(19) United States
(12) Patent Application Publication
(10) Pub. No.: US 2008/0304810 A1
(43) Pub. Date: Dec. 11, 2008

(54) Device for and a Method of Processing an Input Data Stream Comprising a Sequence of Input Frames

(75) Inventors: Albert Maria Arnold Rijckaert, Waalre (NL); Roland Peter Jan Mathijs Manders, Eindhoven (NL); Eric Wilhelmus Josephus Moors, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/097,935

(22) PCT Filed: Nov. 30, 2006
(86) PCT No.: PCT/IB06/54527

§ 371 Date: Jun. 18, 2008

(30) Foreign Application Priority Data
Dec. 23, 2005 (EP) 05112880.9

(51) Int. Cl. H04N 5/95

(52) U.S. Cl. 386/68; 386/E05.037

(57) ABSTRACT

A device (1800) for processing an input data stream comprising a sequence of input frames, wherein the device (1800) comprises a processing unit (1802) for generating an output data stream as a trick-play stream comprising a sequence of output frames based on the input data stream and based on a predetermined replication rate, and a timing unit (1803) for assigning timing information to the output frames, said timing information being based on timing information of the sequence of input frames.

### FIELD OF THE INVENTION

The invention relates to a device for processing an input data stream comprising a sequence of input frames.

The invention further relates to a method of processing an input data stream comprising a sequence of input frames.

The invention further relates to a program element.

The invention further relates to a computer-readable medium.

### BACKGROUND OF THE INVENTION

Electronic entertainment devices become more and more important. Particularly, an increasing number of users buy hard disk based audio/video players and other entertainment equipment.

Since the reduction of storage space is an important issue in the field of audio/video players, audio and video data are often stored in a compressed manner, and for security reasons in an encrypted manner.

MPEG2 is a standard for the generic coding of moving pictures and associated audio and creates a video stream out of frame data that can be arranged in a specified order called the GOP (“Group Of Pictures”) structure. An MPEG2 video bit stream is made up of a series of data frames encoding pictures. The three ways of encoding a picture are intra-coded (I picture), forward predictive (P picture) and bi-directional predictive (B picture). An intra-coded frame (I-frame) is an independently decodable frame. A forward predictive frame (P-frame) needs information of a preceding I-frame or P-frame. A bi-directional predictive frame (B-frame) is dependent on information of a preceding and/or subsequent I-frame or P-frame.

It is an interesting function in a media playback device to switch from a normal reproduction mode, in which media content is played back in a normal speed, to a trick-play reproduction mode, in which media content is played back in a modified manner, for instance with a reduced speed (“slow forward”), a still picture, or vice versa.

US 2003/0053540 A1 discloses processing MPEG coded video data including groups of pictures (GOPs). Each group of pictures includes one or more I-frames and a plurality of B- or P-frames. To produce an MPEG slow-forward coded video stream, the coding type of each frame in the MPEG coded video data is identified, and freeze frames are inserted as a predefined function of the identified coding type and as a predefined function of a desired slow down factor. In one implementation, for a slow-down factor of n, for each original I- or P-frame, (n−1) backward-predicted freeze frames are inserted, and for each original B-frame, (n−1) copies of the original B-frames are added, and a selected amount of padding is added to each copy of each original B-frame in order to obtain a normal play bit rate and avoid video buffer overflow or underflow.

### BRIEF SUMMARY OF THE INVENTION

It is an object of the invention to enable efficient processing of a data stream.

In order to achieve the object defined above, a device for processing an input data stream comprising a sequence of input frames, a method of processing an input data stream comprising a sequence of input frames, a program element and a computer-readable medium according to the independent claims are provided.

According to an exemplary embodiment of the invention, a device for processing an input data stream comprising a sequence of input frames is provided, wherein the device comprises a processing unit for generating an output data stream as a trick-play stream comprising a sequence of output frames based on the input data stream and based on a predetermined replication rate, and a timing unit for assigning timing information to the output frames, said timing information being based on timing information of the sequence of input frames.

According to another exemplary embodiment of the invention, a method of processing an input data stream comprising a sequence of input frames is provided, the method comprising generating an output data stream as a trick-play stream comprising a sequence of output frames based on the input data stream and based on a predetermined replication rate, and assigning timing information to the output frames, said timing information being based on timing information of the sequence of input frames.

Beyond this, according to another exemplary embodiment of the invention, a computer-readable medium is provided, in which a computer program is stored, which computer program, when being executed by a processor, is adapted to control or carry out the above-mentioned method.

Moreover, according to still another exemplary embodiment of the invention, a program element is provided, which program element, when being executed by a processor, is adapted to control or carry out the above-mentioned method.

The data processing according to the invention can be realized by a computer program, that is to say by software, or by using one or more special electronic optimization circuits, that is to say in hardware, or in hybrid form, that is to say by means of software components and hardware components.

According to an exemplary embodiment of the invention, a trick-play stream is generated based on a normal play data stream by repeating frames and/or inserting empty frames between subsequent input frames so as to form a sequence of output frames. However, for this sequence of output frames, timing information may be adjusted to be in accordance with requirements of the trick-play mode with respect to issues like decoding and presentation of the data in correspondence with a trick-play factor. It may be advantageous to derive trick-play stream related timing information on the basis of the original timing information of the input frames, for a correction or an update of this timing information, so as to obtain timing information for the output frame. Taking this measure may reduce the computational burden for calculating timing information, since it may be dispensible to calculate completely new time information independently. In contrast to this, already existing timing information of the original stream may be taken as a platform for simply updating this information so as to obtain trick-play compatible timing information with low effort.

Thus, an embodiment of the invention relates to the placement of output frames on a time axis of a trick-play stream, for instance a slow-forward stream, a slow-reverse stream or a standstill stream. Such an embodiment may make use of the recording time stamps or other timing information pre-pended to the original packets. In order to prevent decoding errors which may occur in case that the decoding starts before the necessary data is received, the distance of the end of the frame data to the decoding time stamp of this frame may be selected to be essentially the same for the trick-play stream and for the normal play stream. For this purpose, the distance of the start of the frame data to the corresponding decoding time stamp may be selected to be the same in the normal-play stream and in the trick-play stream. The packets of this frame may be placed with the same packet distance as in the original normal play stream.

Avoiding decoding problems and ensuring that a proper time relationship between subsequent frames of the output frames is obtained, the playback quality may be significantly improved.

Therefore, the original timing information may be used for generating trick-play, particularly slow-forward trick-play. PCRs (Program Clock References) may be corrected, and, if desired, additional PCRs may be added to the output data stream.

An exemplary embodiment of the invention relates to a storage device for storing MPEG transport streams with a digital interface to an MPEG compliant decoder being capable of providing an MPEG compliant transport stream for slow-forward play mode. Embodiments of the invention provide an algorithm for the placement of frames and packets on an MPEG compliant time axis for a slow-forward stream making use of original timing relation of packets from the normal play stream, that is to say using so-called time stamps. At first, the original normal play frames may be placed on a new time axis for the slow play stream. This may imply correcting the Program Clock Reference (PCR) and the time stamps of the original packets. Repeated B-frames may be placed and again the PCR and the time stamps of the original packets may be corrected.

For large B-frames, all frames but the last repeated B-frame may be compressed in time by correcting packet time stamps. In this context, “large B-frames” may be defined as B-frames exceeding a duration of one frame time. With a frequency of 25 Hz like in Europe, a frame time may equal to a time of essentially 40 ms.

Empty frames which may be necessary for the slow-forward mode may be inserted in a special manner. The first empty frame may be concatenated directly to the previous frame. Subsequent empty frames may be located at time separations of a single frame period. Time stamps of the packets containing the empty frames may be calculated particularly in two ways, namely by using a fixed spacing derived from a previous frame or by equally dispersing the packets over a single frame period. The PCR (Program Clock Reference) at the boundaries of the inserted empty frames may be calculated. The PCR values at the boundaries for the compressed B-frames may also be calculated.

According to an exemplary embodiment, the positioning of frames and packets for slow-forward using the recording time stamps is disclosed. Accordingly, an algorithm for the placement of frames and packets of the slow-forward MPEG stream on the time axis may be provided. According to this algorithm, a new time axis may be created for the slow-forward stream, and the original frames may be placed on this axis in such a way that, in the new stream (that is in the trick-play stream, for instance the slow-forward stream), the distance between the starting of the frame to the corresponding DTS is the same as that of the original normal play stream. This may require a modification of the PCRs.

Furthermore, repeated B-frames may be placed in the appropriate place on the time axis and original PCRs and DTS are corrected.

Beyond this, large frames that occupy more than one frame period, may be compressed in time by adjusting the distance between the packets, which may increase the local bit rate.

Moreover, the empty B-frames may be inserted in a special manner, namely in such a manner that the first repeated frame directly concatenated with the previous frame and the subsequent repeated frames are placed in the time separation of the original display periods. The time stamps may be calculated as average time from the previous frames or by spreading the packets evenly across.

The previous description implies the use of Bf frames. Alternatively, Bb frames or Pe frames (that is to say empty P-frames) can be used. These are however pre-inserted. At least two types of empty B-frames may be distinguished. Empty forward predictive B-frames (so-called Bf-frames) may particularly denote frames referring to an anchor frame preceding the Bf-frame in a display mode. Empty backward predictive B-frames (so-called Bb-frames) may particularly denote frames referring to an anchor frame following the Bb-frame in a display mode. Bf-frames and Bb-frames particularly differ concerning the property at which position they should be inserted in a data stream.

Next, further exemplary embodiments of the invention will be described.

In the following, exemplary embodiments of the device for processing an input data stream comprising a sequence of input frames will be described. However, these embodiments also apply for the method of processing an input data stream comprising a sequence of input frames, for the program element and for the computer-readable medium.

The timing unit may be adapted for assigning the timing information to the output frames, the relative timing information being identical to the relative timing information of the sequence of input frames. If necessary, the timing unit may also correct timing information for trick-play as compared to timing information for normal-play. Therefore, it may be made sure that the timing information of input and output frames are in proper accordance to one another, yielding a proper reproduction quality.

Beyond this, the timing unit may be adapted for adjusting Decoding Time Stamps and/or recording timestamps as the timing information. Both DTS and recording timestamp may be adjusted, but in such a way that their time difference does not change. Decoding Time Stamps may occur in an MPEG data stream which is played back in a normal-play operation mode or in a trick-play operation mode, particularly in a slow-forward mode.

The timing unit may further be adapted for assigning the timing information to the output frames such that a distance (in time) between a start of an output frame and the corresponding Decoding Time Stamp is identical as compared to a distance between a start of an input frame and the corresponding Decoding Time Stamp. By taking this measure, decoding problems and synchronization problems may be avoided, and it may be ensured that the trick-play stream may be reproduced without artefacts in a broad range of values of the replication factor or trick-play factor.

The timing unit may further be adapted for inserting a timing packet in the sequence of the output frames at a position between subsequent output frames to be reproduced for the first time. In trick-play, frames may either be played back several times (like B-frames), or anchor frames (like I-frames, P-frames) may be followed by empty frames. Such timing packets inserted between frames played back for the first time may be Program Clock References (PCR) in the context of an MPEG2 stream. Such a packet may comprise timing information required for synchronizing the decoding and the presentation of the subsequent frames.

Such an inserted timing packet of the output stream may be corrected with respect to a timing packet of the sequence of the input frames. Performing such a correction, different requirements resulting from the trick-play mode as compared to a normal play mode may be taken into account.

The processing unit may be adapted for generating the output frames of the output data stream by stretching the input frames of the input data stream along a time axis in accordance with the predetermined replication rate. When the trick-play factor has a value of 3, for instance, the input frames should be stretched by this factor 3 along the time axis so as to provide for a trick-play stream which is determined based on this trick-play factor or replication rate.

The processing unit may be adapted such that a bi-directional predictive frame (B-frame) is repeated a number of times in accordance with the predetermined replication rate. In a slow-forward trick-play mode of an MPEG2 stream, bi-directional predictive frames should not be stuffed with empty frames, but should be repeated several times. Taking this measure may also be possible for I-frames or P-frames. However, it is in many cases more desired that anchor frames (I-frames or P-frames) are repeated by inserting empty frames in contrast to a simple repetition of the anchor frames.

The timing unit may be adapted for assigning timing information to the repeated bi-directional predictive frames in the same manner as timing information is assigned to bi-directional predictive frames reproduced for the first time. Therefore, since several B-frames are simply repeated in the trick-play stream, the timing information should be properly assigned to each of the B-frames.

The timing unit may further be adapted such that bi-directional predictive frames having a size exceeding a predetermined threshold value (of, for instance, a frame time) are compressed in time. This will be illustrated in FIG. 48 described below. For Europe, a frequency of 25 Hz equals to a frame time of 40 ms which may be taken as the predetermined threshold value so that a B-frame exceeding a size of 40 ms may be compressed.

The timing unit may further be adapted such that bi-directional predictive frames having a size exceeding a predetermined threshold value are compressed in time with exception of a last one of repeated bi-directional predictive frames. In principle one might say that only the last bi-directional predictive frame of a series may stay as it is, wherein the duration of all other preceding bi-directional frames may be adjusted equally by shortening the duration of the B-frames along the time axis.

The processing unit may further be adapted such that anchor frames are filled with empty frames in accordance with the predetermined replication rate. The term “anchor frame” may particularly denote a frame which, in transmission order and/or in display order, keeps its relative temporal position with respect to other anchor frames. In the context of MPEG2, I-frames and P-frames may be denoted as anchor frames. In contrast to this, B-frames would not be denoted as anchor frames in the context of MPEG2.

The processing unit may be adapted for generating the output data stream in a trick-play reproduction mode of the group consisting of a slow-forward reproduction mode, a slow-reverse reproduction mode, a stand still reproduction mode, a step reproduction mode, and an instant replay reproduction mode. This trick-play generation may be adjusted or controlled by a user by selecting corresponding options in a user interface, for instance buttons of a device, a keypad or a remote control. For trick-play, only a portion of subsequent data shall be used for output (for instance for visual display and/or for acoustical output) or the same content may be used several times.

The input frames and/or the output frames may include at least one frame of the group consisting of an intra-coded frame (I-frame), a forward predictive frame (P-frame) and a bi-directional predictive frame (B-frame). Such frames may be part of an MPEG2 video bit stream. An intra-coded frame is related to a particular picture and contains the corresponding data. A forward predictive frame needs information of a preceding I-frame or B-frame. A bi-directional predictive frame may be dependent on information of a preceding and/or of a subsequent I-frame or P-frame.

The device may comprise a storing unit for storing the input data stream and/or the output data stream. Such a storage unit may be a hard disk, a flash card or any other data carrier like a CD or a DVD. However, the storage unit may also be an Internet server to which the device has (network) access for downloading required information.

The device may further be adapted to process a plaintext data stream, a fully encrypted data stream or a mixture of encrypted parts and plaintext parts (a so-called hybrid stream). In other words, the entire data streams may be entirely encrypted or entirely decrypted or may be a combination of both. Thus, decrypters and/or encryptors may be foreseen at appropriate positions of a data processing device according to an embodiment of the invention.

The device may further be adapted to process a data stream of video data or audio data. However, such content is not the only type of data which may be processed with the scheme according to embodiments of the invention. Trick-play generation in similar applications may be an issue for both, video processing and (pure) audio processing.

The device may further be adapted to process a data stream of digital data.

Furthermore, the device may comprise a reproduction unit for reproducing the processed data stream. Such a reproduction unit may comprise a loudspeaker or earphones and/or an optical display device so that both, audio and visual data can be reproduced perceivable for a human being.

The device according to exemplary embodiments of the invention may be adapted to process an MPEG2 data stream. MPEG2 is a designation for a group of audio and video coding standards agreed upon by MPEG (moving pictures experts group), and published as the ISO/IEC 13818 International Standard. For example, MPEG2 is used to encode audio and video broadcast signals including digital satellite and cable TV, but may also be used for DVD.

However, the device according to exemplary embodiments of the invention may also be adapted to process an encrypted MPEG4 data stream. More generally, any codec scheme may be implemented which uses anchor frames from which other frames are dependent, particularly any type of encoding using predictive frames and thus any kind of MPEG encoding/decoding.

The device according to embodiments of the invention may be realized as one of the group consisting of a digital video recording device, a network-enabled device, a conditional access system, a portable audio player, a portable video player, a mobile phone, a DVD player, a CD player, a hard disk based media player, an Internet radio device, a public entertainment device, and an MP3 player. However, these applications are only exemplary.

The aspects defined above and further aspects of the invention are apparent from the examples of embodiment to be described hereinafter and are explained with reference to these examples of embodiment.

### BRIEF DESCRIPTION OF THE DRAWINGS

The invention will be described in more detail hereinafter with reference to examples of embodiment but to which the invention is not limited.

FIG. 1 illustrates a time-stamped transport stream packet.

FIG. 2 shows an MPEG2 group of picture structure with intra-coded frames and forward predictive frames.

FIG. 3 illustrates an MPEG2 group of picture structure with intra-coded frames, forward predictive frames and bi-directional predictive frames.

FIG. 4 illustrates a structure of a characteristic point information file and stored stream content.

FIG. 5 illustrates a system for trick-play on a plaintext stream.

FIG. 6 illustrates time compression in trick-play.

FIG. 7 illustrates trick-play with fractional distance.

FIG. 8 illustrates low speed trick-play.

FIG. 9 illustrates a general conditional access system structure.

FIG. 10 illustrates a digital video broadcasting encrypted transport stream packet.

FIG. 11 illustrates a transport stream packet header of the digital video broadcasting encrypted transport stream packet of FIG. 10.

FIG. 12 illustrates a system allowing the performance of trick-play on a fully encrypted stream.

FIG. 13 illustrates a full transport stream and a partial transport stream.

FIG. 14 illustrates Entitlement Control Messages for a stream type I and for a stream type II.

FIG. 15 illustrates writing Control Words to a decrypter.

FIG. 16 illustrates Entitlement Control Message handling in a fast forward mode.

FIG. 17 illustrates detection of one or two Control Words.

FIG. 18 illustrates a device for processing a data stream according to an exemplary embodiment.

FIG. 19 illustrates splitting of the packet at a frame boundary.

FIG. 20 illustrates slow-forward construction after decryption of normal play data.

FIG. 21 illustrates a hybrid stream with plaintext packets on each frame boundary.

FIG. 22 illustrates slow-forward construction on a stored hybrid stream.

FIG. 23 illustrates an incomplete picture start code at the concatenation point.

FIG. 24 illustrates the effect of reordering in normal play.

FIG. 25 illustrates the effect of reordering in slow-forward mode.

FIG. 26 illustrates the insertion of empty P-frames before the anchor frames.

FIG. 27 illustrates the use of backward predictive empty B-frames.

FIG. 28 illustrates the use of forward predictive empty B-frames.

FIG. 29 illustrates a temporal reference for normal play.

FIG. 30 illustrates a temporal reference for slow-forward with Bf-frames.

FIG. 31 illustrates a temporal reference for pre-insertion of Bb-frames.

FIG. 32 illustrates a temporal reference for pre-insertion of Pe-frames.

FIG. 33 illustrates a temporal references for three types of B-frames.

FIG. 34 illustrates a distance D and a slow motion factor L for a normal play and a slow-forward stream.

FIG. 35 illustrates a temporal reference for the I-frame with empty B-frames used.

FIG. 36 illustrates a temporal reference for the P-frame when empty B-frames are used.

FIG. 37 illustrates a temporal reference for the I-frame when empty P-frames are used.

FIG. 38 illustrates a temporal reference for the P-frame when empty P-frames are used.

FIG. 39 illustrates a temporal reference for empty P-frames.

FIG. 40 illustrates the splitting of the stream for one PES packet per frame.

FIG. 41 illustrates the splitting of the stream at the start of a PES header.

FIG. 42 illustrates the splitting of the stream at the start of a Picture Start Code.

FIG. 43 illustrates the splitting of the stream within a Picture Start Code.

FIG. 44 illustrates an incomplete picture start code at the concatenation point.

FIG. 45 illustrates an example of n+m=4.

FIG. 46 illustrates an example of n+m>4.

FIG. 47 illustrates an example of n+m<4.

FIG. 48 shows a table illustrating Delta as a function of the frame rate.

FIG. 49 illustrates an unmodified distance to DTS.

FIG. 50 illustrates an equal offset at the boundaries of a series of identical B-frames.

FIG. 51 illustrates a B-frame data length.

FIG. 52 illustrates an overlap of data in case the B-frame is larger than one frame time.

FIG. 53 illustrates compression of B-frame with evenly distributed packets.

FIG. 54 illustrates placement of the empty frames.

FIG. 55 illustrates positioning of the first packet of the empty frames.

FIG. 56 illustrates a packet distance of the empty frame based on a previous frame.

FIG. 57 illustrates packets of the empty frame evenly distributed over one frame time.

The Figures are schematically drawn and not true to scale, and the identical reference numerals in different Figures refer to corresponding elements. It will be clear for those skilled in the art, that alternative but equivalent embodiments of the invention are possible without deviating from the true inventive concept, and that the scope of the invention will be limited by the claims only.

### DETAILED DESCRIPTION OF THE INVENTION

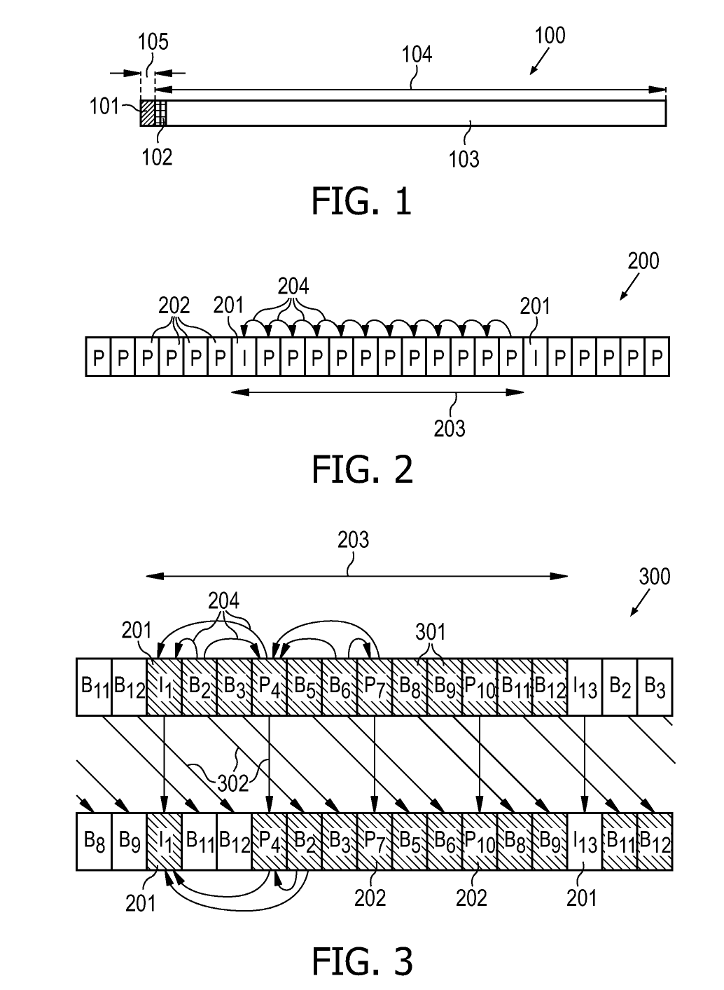

In the following, referring to FIG. 1 to FIG. 13, different aspects of trick-play implementation for transport streams according to exemplary embodiments of the invention will be described.

Particularly, several possibilities to perform trick-play on an MPEG2 encoded stream will be described, which may be partly or totally encrypted, or non-encrypted. The following description will target methods specific to the MPEG2 transport stream format. However, the invention is not restricted to this format.

Experiments were actually done with an extension, the so-called time-stamped transport stream. This comprises transport stream packets, all of which are pre-pended with a 4 bytes header in which the transport stream packet arrival time is placed. This time may be derived from the value of the program clock reference (PCR) time-base at the time the first byte of the packet is received at the recording device. This is a proper method to store the timing information with the stream, so that playback of the stream becomes a relatively easy process.

One problem during playback is to ensure that the MPEG2 decoder buffer will not overrun nor underflow. If the input stream was compliant to the decoder buffer model, restoring the relative timing ensures that the output stream is also compliant. Some of the trick-play methods described herein are independent of the time stamp and perform equally well on transport streams with and without time stamps.

FIG. 1 illustrates a time stamped transport stream packet 100 having a total length 104 of 188 Bytes and comprising a time stamp 101 having a length 105 of 4 Bytes, a packet header 102, and a packet payload 103 having a length of 184 Bytes. This following description will give an overview of the possibilities to create an MPEG/DVB (digital video broadcasting) compliant trick-play stream from a recorded transport stream and intends to cover the full spectrum of recorded streams from those that are completely plaintext, so every bit of data can be manipulated, to streams that are completely encrypted (for instance according to the DVB scheme), so that only transport stream headers and some tables may be accessible for manipulation.

When creating trick-play for an MPEG/DVB transport stream, problems may arise when the content is at least partially encrypted. It may not be possible to descend to the elementary stream level, which is the usual approach, or even access any packetized elementary stream (PES) headers before decryption. This also means that finding picture frames is not possible. Known trick-play engines need to be able to access and process this information.

In the frame of this description, the term “ECM” denotes an Entitlement Control Message. This message may particularly comprise secret provider proprietary information and may, among others, contain encrypted Control Words (CW) needed to decrypt the MPEG stream. Typically, Control Words expire in 10-20 seconds. The ECMs are embedded in packets in the transport stream.

In the frame of this description, the term “keys” particularly denotes data that may be stored in a smart card and may be transferred to the smart card using EMMs, that is so-called “Entitlement Management Messages” that may be embedded in the transport stream. These keys may be used by the smart card to decrypt the Control Words present in the ECM. An exemplary validity period of such a key is one month. In the frame of this description, the term “Control Words” (CW) particularly denotes decryption information needed to decrypt actual content. Control words may be decrypted by the smart card and then stored in a memory of the decryption core.

Some aspects related to trick-play on plaintext streams will now be described.

It is preferable that any MPEG2 streams created are MPEG2 compliant transport streams. This is because the decoder may not only be integrated within a device, but may also be connected via a standard digital interface, such as an IEEE1394 interface, for example.

Account should also be taken of any problems that may occur when using a video coding technique like MPEG2 that exploits the temporal redundancy of video to achieve high compression ratios. Frames may no longer be decoded independently. A structure of a plurality of groups of pictures (GOPs) is shown in FIG. 2. Particularly, FIG. 2 shows a stream 200 comprising several MPEG2 GOP structures with a sequence of I-frames 201 and P-frames 202. The GOP size is denoted with reference numeral 203. The GOP size 203 is set to 12 frames, and only I-frames 201 and P-frames 202 are shown here.

In MPEG, a GOP structure may be used in which only the first frame is coded independently of other frames. This is the so-called intra-coded or I-frame 201. The predictive frames or P-frames 202 are coded with a unidirectional prediction, meaning that they only rely on the previous I-frame 201 or P-frame 202 as indicated by arrows 204 in FIG. 2. Such a GOP structure has typically a size of 12 or 16 frames 201, 202. Another structure 300 of a plurality of GOPs is shown in FIG. 3. Particularly, FIG. 3 shows the MPEG2 GOP structure with a sequence of I-frames 201, P-frames 202 and B-frames 301. The GOP size is again denoted with reference numeral 203.

It is possible to use a GOP structure containing also bi-directionally predictive frames or B-frames 301 as shown in FIG. 3. A GOP size 203 of 12 frames is chosen for the example. The B-frames 301 are coded with a bi-directional prediction, meaning that they rely on a previous and a next I- or P-frame 201, 202 as indicated for some B-frames 301 by curved arrows 204. The transmission order of the compressed frames may be not the same as the order in which they are displayed.

To decode a B-frame 301, both reference frames before and after the B-frame 301 (in display order) are needed. To minimize the buffer demand in a decoder, the compressed frames may be reordered. So in transmission, the reference frames may come first. The reordered stream, as it is transmitted, is also shown in FIG. 3, lower part. The reordering is indicated by straight arrows 302. A stream containing B-frames 301 can give a nice looking trick-play picture if all the B-frames 301 are skipped. For the present example, this leads to a trick-play speed of 3× forward.

Even if an MPEG2 stream is not encrypted (that is to say plaintext), trick-play is not trivial. The possibility of a slow-reverse based on I-frames only is briefly mentioned. An efficient frame based slow-reverse is more difficult though, due to the necessary inversion of the MPEG2 GOP. Slow-forward which is also known as slow motion forward is a mode in which the display picture runs at a lower than normal speed. A rudimentary form of slow-forward is already possible with the technique making use of a fast-forward algorithm that generates trick-play GOPs. Setting the fast-forward speed to a value between zero and one results in a slow-forward stream based on a repetition of fast-forward trick-play GOPs. For a plaintext stream this is no problem but for an encrypted stream it can lead to the erroneous decryption of part of the I-frame in certain specific conditions. There are several options to solve this problem but the most suitable way is not to repeat the fast-forward trick-play GOP but to extend the size of the trick-play GOP by the addition of empty P-frames. This technique in fact also enables slow-reverse, because it is based on the trick-play GOPs used for fast-forward/reverse and therefore on the independently decodable I-frames. However, it is not preferred to make use of this kind of I-frame based slow-forward or slow-reverse for the following reason. The distance between I-frames in normal play is around half a second and for slow-forward/reverse it is multiplied with the slow motion factor. So this type of slow-forward or slow-reverse is not really the slow motion consumers are used to but in fact it is more like a slide show with a large temporal distance between the successive pictures.

In another trick-play mode called still picture mode the display picture is halted. This can be achieved by adding empty P-frames to the I-frame for the duration of the still picture mode. This means that the picture resulting from the last I-frame is halted. When switching to still picture from normal play, this can also be the nearest I-frame according to the data in the CPI file. This technique is an extension of the fast-forward/reverse modes and results in nice still pictures especially if interlace kill is used. However the positional accuracy is often not sufficient when switching from normal play or slow-forward/reverse to still picture.

The still picture mode can be extended to implement a step mode. The step command advances the stream to some next or previous I-frame. The step size is at minimum one GOP but can also be set to a higher value equal to an integer number of GOPs. Step forward and step backward are both possible in this case because only I-frames are used.

The slow-forward can also be based on a repetition of every frame, which results in a much smoother slow motion. The best form of slow-forward would in fact be a repetition of fields instead of frames because the temporal resolution is doubled and there are no interlace artifacts. This is however practically impossible for the intrinsically frame based MPEG2 streams and even more so if they are largely encrypted. The interlace artifacts can be significantly reduced for the I- and P-frames by using special empty frames to force the repetition. Such an interlace reduction technique is not available for the B-frames though. Whether the use of interlace kill for the I- and P-frames is still advantageous in this case or in fact leads to a more annoying picture for the viewer can only be verified by experiments.

Slow-reverse on the basis of individual frames is in fact very complicated for MPEG signals due to the temporal predictions. A complete GOP has to be buffered and reversed. There is no simple method that we know of to recode the frames in a GOP to the reverse order. So an almost complete decoding and encoding might be necessary with an inversion of the frame order between these two. This asks for the buffering of a complete decoded GOP as well as an MPEG decoder and encoder.

Still picture mode can be defined as an extension of the frame-based slow-forward mode. It is based on a repeated display of the current frame for the duration of the still picture mode whatever the type of this frame is. This is in fact a slow-forward with an infinite slow motion factor if this indicates the factor with which the normal play stream is slowed down. No interlace kill is possible if the picture is halted on a B-frame. In that sense this still picture mode is worse than the trick-play GOP based still picture mode. This can be corrected by only halting the picture at an I- or P-frame at the cost of a somewhat less accurate still picture position. Discontinuities in the temporal reference and the PTS can also be avoided in this case. Moreover, the bit rate is significantly reduced because the repetition of an I- or P-frame is forced by the insertion of empty frames instead of a repetition of the frame data itself as is necessary for the B-frames. So, technically speaking, the halting of a picture at an I- or P-frame is the best choice.

The still picture mode can also be extended with a step mode. The step command advances the stream in principle to the next frame. Larger step sizes are possible by stepping to the next P-frame or some next I-frame. A step backward on frame basis is not possible. The only option is to step backward to one of the previous I-frames.

Two types of still picture mode have been mentioned, namely trick-play GOP based and frame based. The first one is most logically connected to fast-forward/reverse whereas the second one is related to slow-forward. When switching from some mode to still picture, it is preferable to choose the related still picture mode to minimize the switching delay. The streams resulting from both methods look very alike because they are both based on the insertion of empty frames to force the repetition of an anchor frame. But on detailed stream construction level there are some differences.

In the following, some aspects related to a CPI (“characteristic point information”) file will be described.

Finding I-frames in a stream usually requires parsing the stream, to find the frame headers. Locating the positions where the I-frame starts can be done while the recording is being made, or off-line after the recording is completed, or semi on-line, in fact being off-line but with a small delay with respect to the moment of recording. The I-frame end can be found by detecting the start of the next P-frame or B-frame. The meta-data derived this way can be stored in a separate but coupled file that may be denoted as characteristic point information file or CPI file. This file may contain pointers to the start and eventually end of each I-frame in the transport stream file. Each individual recording may have its own CPI file.

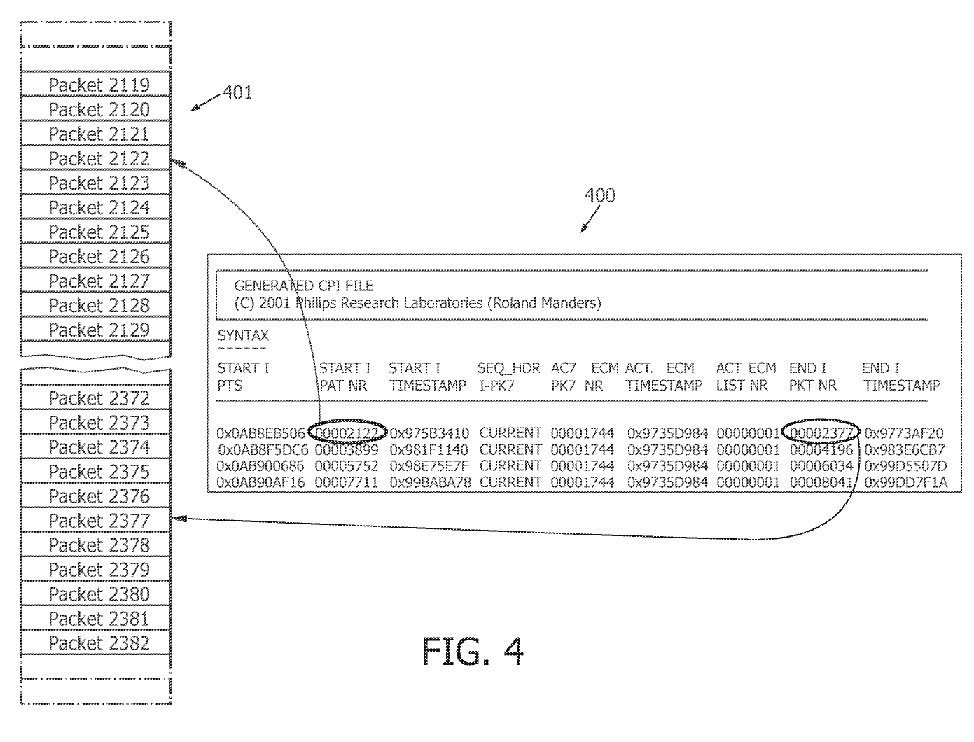

The structure of a characteristic point information file 400 is visualized in FIG. 4.

Apart from the CPI file 400, stored information 401 is shown. The CPI file 400 may also contain some other data that are not discussed here.

With the data from the CPI file 400 it is possible to jump to the start of any I-frame 201 in the stream. If the CPI file 400 also contains the end of the I-frames 201, the amount of data to read from the transport stream file is exactly known to get a complete I-frame 201. If for some reason the I-frame end is not known, the entire GOP or at least a large part of the GOP data is to be read to be sure that the entire I-frame 201 is read. The end of the GOP is given by the start of the next I-frame 201. It is known from measurements that the amount of I-frame data can be 40% or more of the total GOP data.

It is known that reducing the trick-play picture refresh rate can be achieved by displaying each I-frame 201 several times. The bit rate will be reduced accordingly. This may be achieved by adding so-called empty P-frames 202 between the I-frames 201. Such an empty P-frame 202 is not really empty but may contain data instructing the decoder to repeat the previous frame. This has a limited bit cost, which can in many cases be neglected compared to an I-frame 201. From experiments it is known that trick-play GOP structures like IPP or IPPP may be acceptable for the trick-play picture quality and even advantageous at high trick-play speeds. The resulting trick-play bit rate is of the same order as the normal play bit rate. It is also mentioned that these structures may reduce the required sustained bandwidth from the storage device.

Here some aspects related to timing issues and stream construction will be described.

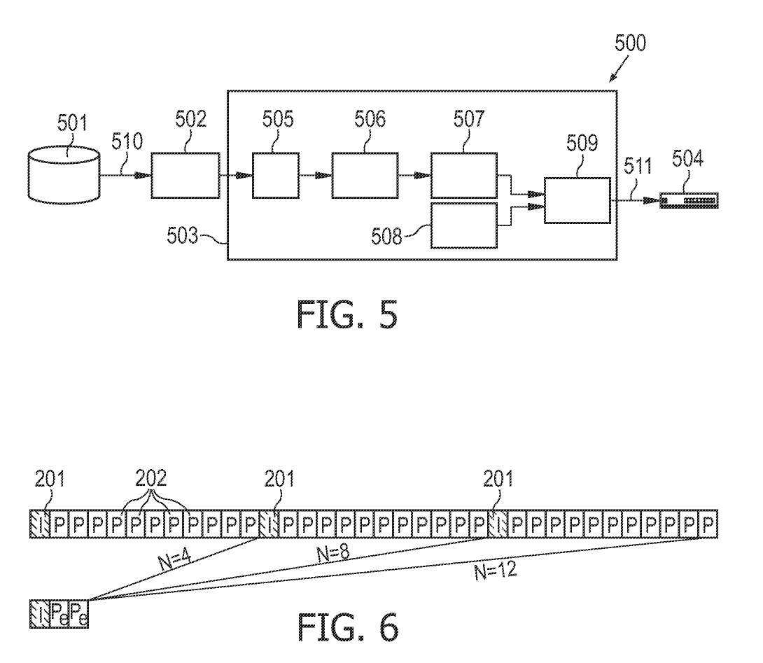

A trick-play system 500 is schematically depicted in FIG. 5.

The trick-play system 500 comprises a recording unit 501, an I-frame selection unit 502, a trick-play generation block 503 and an MPEG2 decoder 504. The trick-play generation block 503 includes a parsing unit 505, an adding unit 506, a packetizer unit 507, a table memory unit 508 and a multiplexer 509.

The recording unit 501 provides the I-frame selection unit 502 with plaintext MPEG2 data 510. The multiplexer 509 provides the MPEG2 decoder 504 with an MPEG2 DVB compliant transport stream 511.

The I-frame selector 502 reads specific I-frames 201 from the storage device 501. Which I-frames 201 are chosen depends on the trick-play speed as will be described below. The retrieved I-frames 201 are used to construct an MPEG-2/DVB compliant trick-play stream that is then sent to the MPEG-2 decoder 504 for decoding and rendering.

The position of the I-frame packets in the trick-play stream cannot be coupled to the relative timing of the original transport stream. In trick-play, the time axis may be compressed or expanded with the speed factor and additionally inversed for reverse trick-play. Therefore, the time stamps of the original time stamped transport stream may not be suitable for trick-play generation.

Moreover, the original PCR time base may be disturbing for trick-play. First of all it is not guaranteed that a PCR will be available within the selected I-frame 201. But even more important is that the frequency of the PCR time base would be changed. According to the MPEG2 specification, this frequency should be within 30 ppm from 27 MHz. The original PCR time base fulfils this requirement, but if used for trick-play it would be multiplied by the trick-play speed factor. For reverse trick-play this even leads to a time base running in the wrong direction. Therefore, the old PCR time base has to be removed and a new one added to the trick-play stream.

Finally, I-frames 201 normally contain two time stamps that tell the decoder 504 when to start decoding the frame (decoding time stamp, DTS) and when to start presenting, for instance displaying, it (presentation time stamp, PTS). Decoding and presentation may be started when DTS respectively PTS are equal to the PCR time base, which is reconstructed in the decoder 504 by means of the PCRs in the stream. The distance between, e.g., the PTS values of 2 I-frames 201 corresponds to their nominal distance in display time. In trick-play this time distance is compressed or expanded with the speed factor. Since a new PCR time base is used in trick-play, and because the distance for DTS and PTS is no longer correct, the original DTS and PTS of the I-frame 201 have to be replaced.

To solve above-mentioned complications, the I-frame 201 may first be parsed into an elementary stream in the parsing unit 505. Then the empty P-frames 202 are added on elementary stream level. The obtained trick-play, GOP is mapped into one PES packet and packetized to transport stream packets. Then corrected tables like PAT, PMT, etc. are added. At this stage, a new PCR time base together with DTS and PTS are included. The transport stream packets are pre-pended with a 4 bytes time stamp that is coupled to the PCR time base such that the trick-play stream can be handled by the same output circuitry as used for normal play.

In the following, some aspects related to trick-play speeds will be described. In this context, firstly, fixed trick-play speeds will be discussed.

As mentioned before, a trick-play GOP structure like IPP may be used in which the I-frame 201 is followed by two empty P-frames 202. It is assumed that the original GOP has a GOP size 203 of 12 frames and that all the original I-frames 201 are used for trick-play. This means that the I-frames 201 in the normal play stream have a distance of 12 frames and the same I-frames 201 in the trick-play stream a distance of 3 frames. This leads to a trick-play speed of 12/3=4x. If the original GOP size 203 in frames is denoted by G, the trick-play GOP size in frames by T and the trick-play speed factor by N_{b}, the trick-play speed in general is given by:

N_{b}=G/T (1)

N_{b} will also be denoted as the basic speed. Higher speeds can be realized by skipping I-frames 201 from the original stream. If every second I-frame 201 is taken, the trick-play speed is doubled, if every third I-frame 201 is taken, the trick-play speed is tripled and so on. In other words, the distance between the used I-frames 201 of the original stream is 2, 3 and so on. This distance may be always an integer number. If the distance between the I-frames 201 used for trick-play generation is denoted by D (D=1 meaning that every I-frame 201 is used), then the general trick-play speed factor N is given by:

N=D*G/T (2)

This means that all integer multiples of the basic speed can be realized, leading to an acceptable set of speeds. It should be noticed that D is negative for reverse trick-play and that D=0 results in a still picture. Data can only be read in a forward direction. Therefore, in reverse trick-play, data is read forward and jumps are made backwards to retrieve the preceding I-frame 201 given by D. It should also be noticed that a larger trick-play GOP size T results in a lower basic speed. For instance, IPPP leads to a finer grained set of speeds than IPP.

Referring to FIG. 6, time compression in trick-play will be explained.

FIG. 6 shows the situation for T=3 (IPP) and G=12. For D=2, an original display time of 24 frames is compressed into a trick-play display time of 3 frames resulting in N=8. In the given example, the basic speed is an integer but this is not necessarily the case. For G=16 and T=3, the basic speed is 16/3=5⅓ which does not result in a set of integer trick-play speeds. Therefore, the IPPP structure (T=4) is better suited for a GOP size of 16 resulting in a basic speed of 4×. If a single trick-play structure is desired that fits to the most common GOP sizes of 12 and 16, IPPP may be chosen.

Secondly, arbitrary trick-play speeds will be discussed.

In some cases, the set of trick-play speeds resulting from the method described above is satisfying, in some cases not. In the case of G=16 and T=3 one probably still would prefer integer trick-play speed factors. Even in the case of G=12 and T=4 it might be preferred to have a speed not available in the set like for instance 7×. Now, the trick-play speed formula will be inverted and the distance D will be calculated which is given by:

D=N*T/G (3)

Using the above example with G=12, T=4 and N=7 results in D=2⅓. Instead of skipping a fixed number of I-frames 201, an adaptive skipping algorithm might be used that chooses the next I-frame 201 based on the fact what I-frame 201 best matches the required speed. To choose the best matching I-frame 201, the next ideal point Ip with the distance D may be calculated and one of the I-frames 201 may be chosen closest to this ideal point to construct a trick-play GOP. In the following step, again the next ideal point may be calculated by increasing the last ideal point by D.

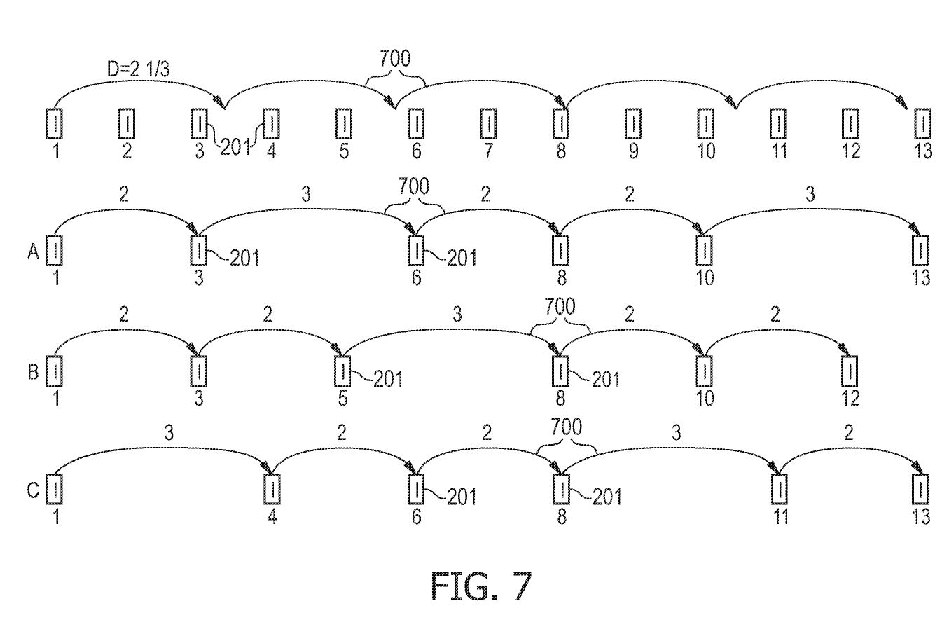

As visualized in FIG. 7 illustrating trick-play with fractional distances, there are particularly three possibilities to choose the I-frame 201:

A. The I-frame closest to the ideal point; I=round(Ip)
B. The last I-frame before the ideal point; I=int(Ip)
C. The first I-frame after the ideal point; I=int(Ip)+1

As can clearly be seen, the actual distance is varying between int(D) and int(D)+1, the ratio between the occurrences of the two being dependent on the fraction of D, such that the average distance is equal to D. This means that the average trick-play speed is equal to N, but that the actually used frame has a small jitter with respect to the ideal frame. Several experiments have been performed with this, and although the trick-play speed may vary locally, this is not visually disturbing. Usually, it is not even noticeable especially at somewhat higher trick-play speeds. It is also clear from FIG. 7 that it makes no essential difference whether to choose method A, B or C.

With this method, trick-play speed N does not need to be an integer but can be any number above the basic speed N_{b}. Also speeds below this minimum can be chosen, but then the picture refresh rate may be lowered locally because the effective trick-play GOP size T is doubled or at still lower speeds even tripled or more. This is due to a repetition of the trick-play GOPs, as the algorithm will choose the same I-frame 201 more than once.

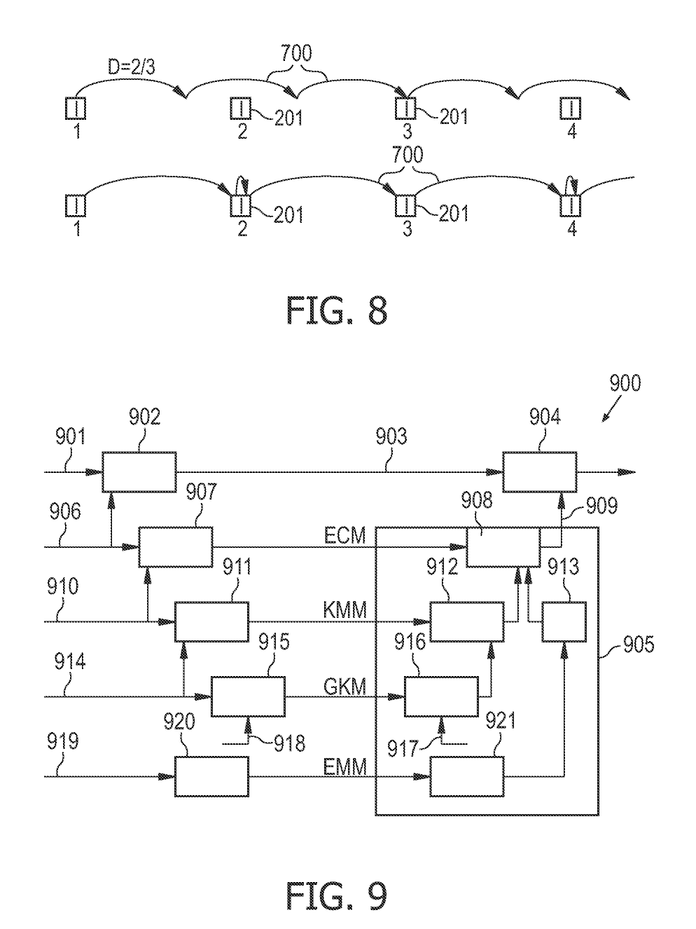

FIG. 8 shows an example for D=⅔ which is equivalent to N=⅔ N_{b}. Here, the round function is used to select the I-frames 201 and as can be seen frames 2 and 4 are selected twice.

Anyway, the described method will allow for a continuously variable trick-play speed. For reverse trick-play a negative value is chosen for N. For the example of FIG. 7 this simply means that the arrows 700 are pointing in the other direction. The method described will also include the sets of fixed trick-play speeds mentioned earlier and they will have the same quality, especially if the round function is used. Therefore, it might be appropriate that the flexible method described in this section should always be implemented whatever the choice of the speeds will be.

Now some aspects related to the refresh rate of the trick-play picture will be discussed.

The term “refresh rate” particularly denotes the frequency with which new pictures are displayed. Although not speed dependent, it will be briefly discussed here because it can influence the choice of T. If the refresh rate of the original picture is denoted by R (25 Hz or 30 Hz), the refresh rate of the trick-play picture (Rₜ) is given by:

Rₜ=R/T (4)

With a trick-play GOP structure of IPP (T=3) or IPPP (T=4), the refresh rate Rₜ is 8⅓ Hz respectively 6¼ Hz for Europe and 10 Hz respectively 7½ Hz for the USA. Although the judgment of trick-play picture quality is a somewhat subjective matter, there are clear hints from experiments that these refresh rates are acceptable for low speeds and even advantageous at higher speeds.

In the following, some aspects related to encrypted stream environments will be described.

Here some information about encrypted transport streams is presented as a basis for the description of trick-play on encrypted streams. It is focussed on the Conditional Access System used for broadcast.

FIG. 9 illustrates a conditional access system 900 which will now be described.

In the conditional access system 900, content 901 may be provided to a content encryption unit 902. After having encrypted the content 901, the content encryption unit 902 supplies a content decryption unit 904 with encrypted content 903. In this specification it has been stated that ECM denotes Entitlement Control Messages. Furthermore, it is meant that KMM denotes Key Management Messages, GKM denotes Group Key Messages and EMM denotes Entitlement Management Messages. A Control Word 906 may be supplied to the content encryption unit 902 and to an ECM generation unit 907. The ECM generation unit 907 generates an ECM and provides the same to an ECM decoding unit 908 of a smart card 905. The ECM decoding unit 908 generates from the ECM a Control Word that is decryption information that is needed and provided to the content encryption unit 904 to decrypt the encrypted content 903.

Furthermore, an authorization key 910 is provided to the ECM generation unit 907 and to a KMM generation unit 911, wherein the latter generates a KMM and provides the same to a KMM decoding unit 912 of the smart card 905. The KMM decoding unit 912 provides an output signal to the ECM decoding unit 908.

Moreover, a group key 914 may be provided to the KMM generation unit 911 and to a GKM generation unit 915 which may further be provided with a user key 918. The GKM generation unit 915 generates a GKM signal GKM and provides the same to a GKM decoding unit 916 of the smart card 905, wherein the GKM decoding unit 916 gets as a further input a user key 917.

Beyond this, entitlements 919 may be provided to an EMM generation unit 920 that generates an EMM signal and provides the same to an EMM decoding unit 921. The EMM decoding unit 921 located in the smart card 905 is coupled with an entitlement list unit 913 which provides the ECM decoding unit 908 with corresponding control information.

In many cases, content providers and service providers want to control access to certain content items through a conditional access (CA) system.

To achieve this, the broadcasted content 901 is encrypted under the control of the CA system 900. In the receiver, content is decrypted before decoding and rendering if access is granted by the CA system 900.

The CA system 900 uses a layered hierarchy (see FIG. 9). The CA system 900 transfers the content decryption key (Control Word CW 906, 909) from server to client in the form of an encrypted message, called an ECM. ECMs are encrypted using an authorization key (AK) 910. For security reasons, the CA server 900 may renew the authorization key 910 by issuing a KMM. A KMM is in fact a special type of EMM, but for clarity the term KMM may be used. KMMs are also encrypted using a key that for instance can be a group key (GK) 914, which is renewed by sending a GKM that is again a special type of EMM. GKMs are then encrypted with the user key (UK) 917, 918, which is a fixed unique key embedded in the smart card 905 and known by the CA system 900 of the provider only. Authorization keys and group keys are stored in the smart card 905 of the receiver.

Entitlements 919 (for instance viewing rights) are sent to individual customers in the form of an EMM and stored locally in a secure device (smart card 905). Entitlements 919 are coupled to a specific program. An entitlements list 913 gives access to a group of programs depending on the type of subscription. ECMs are only processed into keys (Control Words) by the smart card 905 if an entitlement 919 is available for the specific program. Entitlement EMMs are subject to an identical layered structure as the KMMs (not depicted in FIG. 9).

In an MPEG2 system, encrypted content, ECMs and EMMs (including the KMM and GKM types) are all multiplexed into a single MPEG2 transport stream. The description above is a generalized view of the CA system 900. In digital video broadcasting, only the encryption algorithm, the odd/even Control Word structure, the global structure of ECMs and EMMs and their referencing are defined. The detailed structure of the CA system 900 and the way the payloads of ECMs and EMMs are encoded and used are provider specific. Also the smart card is provider specific. However, from experience it is known that many providers follow essentially the structure of the generalized view of FIG. 9.

In the following, DVB Encryption/Decryption topics will be discussed.

The applied encryption and decryption algorithm is defined by the DVB standardization organization. In principle two encryption possibilities are defined namely PES level encryption and TS level encryption. However, in real life mainly the TS level encryption method is used. Encryption and decryption of the transport stream packets is done packet based. This means that the encryption and decryption algorithm is restarted every time a new transport stream packet is received. Therefore, packets can be encrypted or decrypted individually. In the transport stream, encrypted and plaintext packets are mixed because some stream parts are encrypted (e.g. audio/video) and others are not (e.g. tables). Even within one stream part (e.g. video) encrypted and plaintext packets may be mixed.

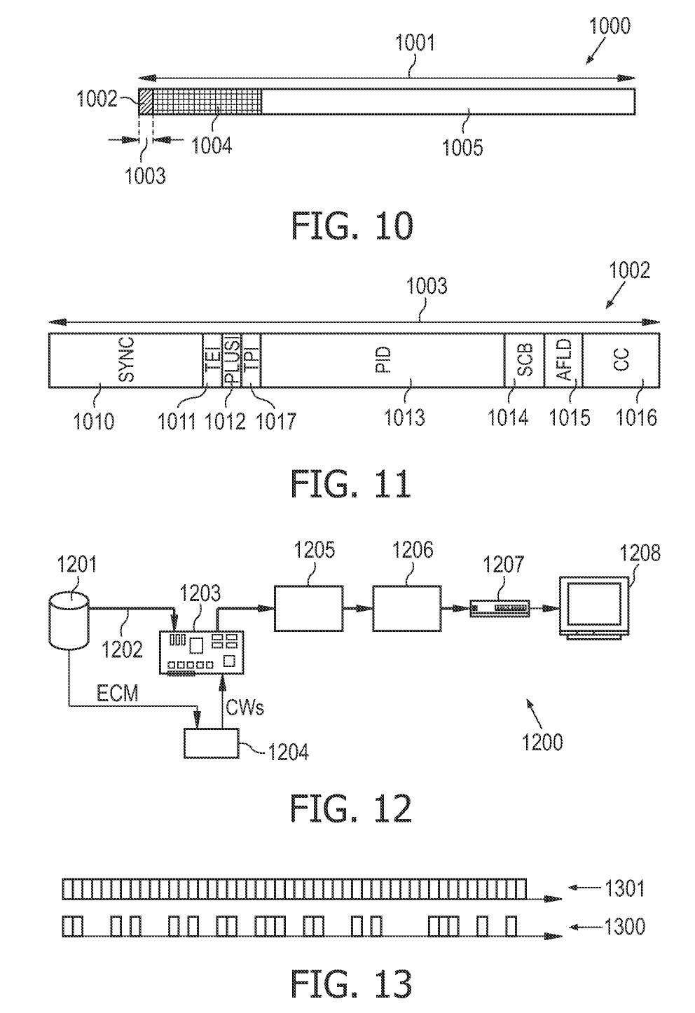

Referring to FIG. 10, a DVB encrypted transport stream packet 1000 will be described.

The stream packet 1000 has a length 1001 of 188 Bytes and comprises three portions. A packet header 1002 has a size 1003 of 4 Bytes. Subsequent to the packet header 1002, an adaptation field 1004 may be included in the stream packet 1000. After that, a DVB encrypted packet payload 1005 may be sent.

FIG. 11 illustrates a detailed structure of the transport stream packet header 1002 of FIG. 10.

The transport stream packet header 1002 comprises a synchronization unit (SYNC) 1010, a transport error indicator (TEI) 1011 which may indicate transport errors in a packet, a payload unit start indicator (PLUSI) 1012 which may particularly indicate a possible start of a PES packet in the subsequent payload 1005, a transport priority unit (TPI) 1017 indicating priority of the transport, a packet identifier (PID) 1013 used for determining the assignment of the packet, a transport scrambling control (SCB) 1014 is used to select the CW that is needed for decrypting the transport stream packet, an adaptation field control (AFLD) 1015, and a continuity counter (CC) 1016. Thus, FIG. 10 and FIG. 11 show the MPEG2 transport stream packet 1000 that has been encrypted and which comprises different parts:

Packet header 1002 is in plaintext. It serves to obtain important information such as a packet identifier (PID) number, presence of an adaptation field, scrambling control bits, etc.

Adaptation field 1004 is also in plaintext. It can contain important timing information such as the PCR.

DVB Encrypted Packet Payload 1005 contains the actual program content that may have been encrypted using the DVB algorithm.

In order to select the correct CW that is needed to decrypt the broadcasted program it is necessary to parse the transport stream packet header. A schematic overview of this header is given in FIG. 11. An important field for the decryption of the broadcasted program is the scrambling control bits (SCB) field 1014. This SCB field 1014 indicates which CW the decrypter must use to decrypt the broadcasted program. Moreover, it indicates whether the payload of the packet is encrypted or in plaintext. For every new transport stream packet, this SCB 1014 must be parsed since it changes over time and can change from packet to packet.

In the following, some aspects related to trick-play on fully encrypted streams will be described.

The first reason why this is an interesting topic is that trick-play on plaintext and fully encrypted streams are the two extremes of a range of possibilities. Another reason is that there exist applications in which it may be necessary to record fully encrypted streams. Thus, it would be useful to have a technique at hand to perform trick-play on a fully encrypted stream. A basic principle is to read a large enough block of data from the storage device, decrypt it, select an I-frame in the block and construct a trick-play stream with it.

Such a system 1200 is depicted in FIG. 12

FIG. 12 shows the basic principle of trick-play on a fully encrypted stream. For this purpose, data stored on a hard disk 1201 are provided as a transport stream 1202 to a decrypter 1203. Further, the hard disk 1201 provides a smart card 1204 with an ECM, wherein the smart card 1204 generates Control Words from this ECM and sends the same to the decrypter 1203.

Using the Control Words, the decrypter 1203 decrypts the encrypted transport stream 1202 and sends the decrypted data to an I-frame detector and filter 1205. From there, the data are provided to an insert empty P frame unit 1206 which conveys the data to a set top box 1207. From there, data are provided to a television 1208.

Some aspects will be mentioned with respect to the question of what a recording contains.

Making a recording of a single channel, the recording must contain all the data required to playback the recording of the channel at a later stage. One can resort to just record everything on a certain transponder, but this way one would record far more than one needs to playback the program intended to record. This means that both bandwidth and storage space would be wasted. So instead of this, only the packets really needed should be recorded. For each program this means one must record all the MPEG2 mandatory packets like PAT (program association table), CAT (conditional access table), and obviously for each program the video and audio packets as well as the PMT (program map table) that describes which packets belong to a program. Furthermore, the CAT/PMT may describe CA packets (ECMs) needed for decryption of the stream. Unless the recording is made in plaintext after decryption, those ECM packets have to be recorded as well.

If the recording made does not consist of all packets from the full multiplex, the recording becomes a so-called partial transport stream 1300 (see FIG. 13). Further, FIG. 13 illustrates a full transport stream 1301. The DVB standard requires that if a partial transport stream 1300 is played, all normal DVB mandatory tables like NIT (network information table), BAT (bouquet association table) etc. are removed. Instead of these tables, the partial stream should have SIT (selection information table) and DIT (discontinuity information table) tables inserted.

In the following, some aspects related to dealing with ECMs will be described.

Jumping to the next block during trick-play can mean jumping back in the stream. It will be explained that this may not be only the case for trick-play reverse but also for trick-play forward at moderate speeds. The situation for forward trick-play with forward jumps and for reverse trick-play with inherently backward jumps will be explained afterwards.

Specific problems may occur caused by the fact that data has to be decrypted. A conditional access system may be designed for transmission. In normal play, the transmitted stream may be reconstructed with original timings. But trick-play may have severe implications for the handling of cryptographic metadata due to changed timings. The data may be compressed or expanded in time due to trick-play, but the latency of the smart card may remain constant.

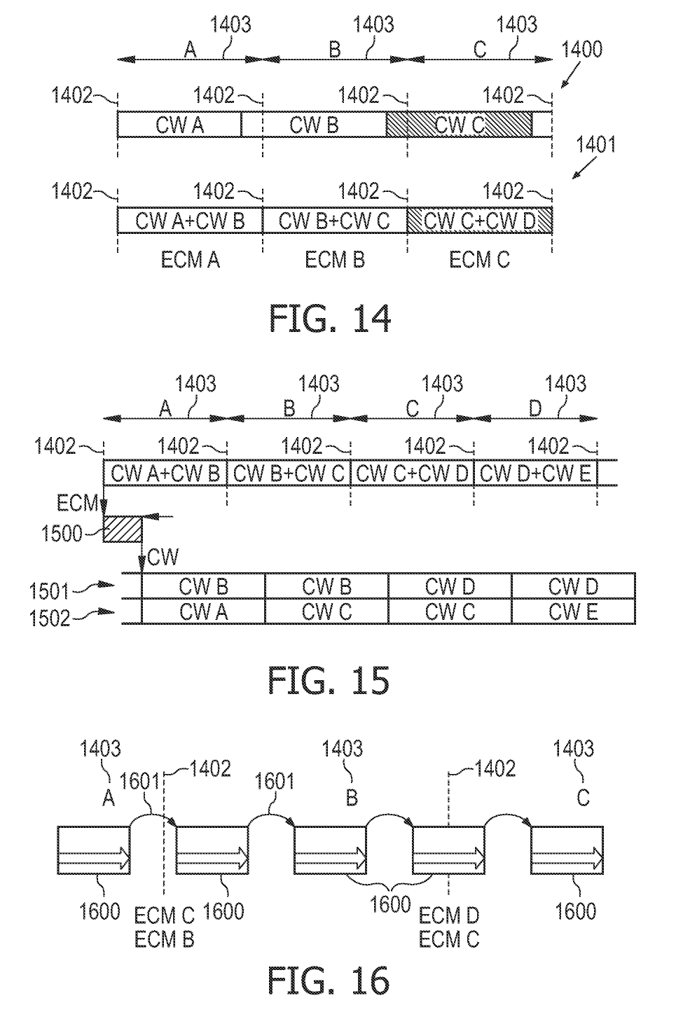

To create a trick-play stream, the mentioned data blocks may go through a decrypter. This decrypter needs the Control Words used in the encryption process to decrypt the data blocks. These Control Words may also be encrypted and stored in ECMs. In a normal set-top-box (STB), these ECMs may be part of the program tuned to. A conditional access module may extract the ECMs, send them to a smart card, and, if the card has rights or an authorization to decrypt these ECMs, may receive the decrypted Control Words from it. Control Words usually have a relatively short lifetime of, for instance, approximately 10 seconds. This lifetime may be indicated by the Scrambling Control Bit, SCB 1014, in the transport stream packet headers. If it changes, the next Control Word has to be used. This SCB change or toggle is indicated in FIG. 14 by a vertical line and with a reference numeral 1402.

Referring to FIG. 14, particularly two different scenarios or stream types may be distinguished:

According to a stream type I shown in a lower row 1401 in FIG. 14, two Control Words (CWs) are provided per ECM.

According to a stream type II shown in an upper row 1400 in FIG. 14, only one Control Word (CW) is provided per ECM.

FIG. 14 illustrates the two data streams 1400, 1401 comprising subsequently arranged periods or segments A, B, C denoted with reference numeral 1403. In the scenario illustrated in the upper row 1400 of FIG. 14, essentially one Control Word per corresponding ECM is provided. In contrast to this, in the lower row 1401, each ECM comprises two Control Words, namely the Control Word relating to the current period or ECM, and additionally the Control Word of the subsequent period or ECM. Thus, there is some redundancy concerning the provision of the Control Words.

During the short lifespan, items of the decryption information may be transmitted several times, so that tuning to such a channel halfway through the lifespan of such a Control Word does not mean waiting for the next Control Word. The conditional access module may only send the first unique ECM it finds to the smart card to reduce or minimize the traffic to the card, as it may have a fairly slow processor.

This shows that there may be a limitation of trick-play on encrypted streams. There may be an implicit upper speed limit, coming from the limited speed of the processing capability of the smart card. In trick-play, the Control Word lifetime of 10 seconds may be compressed or expanded with the trick-play speed factor. Sending an ECM to a smart card and receiving the decrypted Control Words may take approximately half a second. The way Control Words are packed into an ECM may be provider-specific and particularly different for stream type I and stream type II, as depicted in FIG. 14.

CW A denotes the CW that was used to encrypt period A, CW B denotes the CW that was used to encrypt period B, and so on. Horizontally, the transmission time axis is plotted. ECM A may be defined as being the ECM that is present during the major part of period A. It can be seen that, in that case, ECM A holds the CW for the current period A and for stream type I additionally for the next period B. In general, an ECM may hold at least the CW for the current period and might hold the CW for the next period. Due to zapping, this may probably be true for all or many providers.

Before going on, more information will be provided about a decrypter and how it may handle the CWs. The decrypter may contain two registers, one for the “odd” and one for the “even” CW. “Odd” and “even” does not have to mean that the values of the CWs themselves are odd or even. The terms are particularly used to distinguish between two subsequent CWs in the stream. Which CW has to be used for the decryption of a packet is indicated by the SCB 1014 in the packet header. So the CWs used to encrypt the stream are alternating between odd and even. In FIG. 14 this means that, for instance, CW A and CW C are odd, whereas CW B and CW D are even. After the decryption by the smart card, CWs may be written to the corresponding registers in the decrypter overwriting previous values, as indicated in FIG. 15.

FIG. 15 illustrates the two registers 1501, 1502 containing even CWs (register 1501) and containing odd CWs (register 1502). Further, smart card latency 1500, that is a time needed by the smart card to retrieve or decrypt a CW from an ECM, is illustrated in FIG. 15.

In the case of stream type I, each LCM holds two CWs and as a result both registers 1501, 1502 may be overwritten after the decryption of the ECM. One of the registers 1501, 1502 is active and the other is inactive. Which one is active depends on the SCB 1014. In the example, the SCB 1014 will indicate during period B that the even register 1501 is the active one. The active register may only be overwritten with a CW identical to the one it already holds because it is still needed for decryption of the remainder of that particular period. Therefore, only the inactive register may be overwritten with a new value.

Taking a closer look at period B in trick-play. Assuming that an ECM is sent to the smart card at the start of this period so at the moment the SCB toggle 1402 is crossed. The question is what ECM could then be sent to the smart card?

This LCM should hold CW C to ensure a timely decryption by the smart card for usage at the start of period C.

It may also hold CW B without disturbing the correct availability of CWs in the decrypter.

Looking again at FIG. 14, it can be seen that for stream type I this means sending ECM B and for stream type II ECM C at the start of period B. In general, the current ECM can be sent in case it holds two CWs, and one period in advance if it holds only one CW. Sending an ECM one period in advance may be contradictory though to the embedded ECMs, so the latter have to be removed from the stream in that case. For a more generalized approach it may be preferred that the original ECMs are always removed from the stream by the trick-play generation circuitry or software. However, this cannot always be true.

FIG. 16 shows ECM handling in a fast forward mode.

In a plurality of subsequent periods 1403 separated by SCB toggles 1402, a plurality of data blocks 1600 are reproduced, wherein a switching 1601 occurs between different data blocks.

For stream type I, an ECM B is sent at a border between periods A and B. For stream type II, an ECM C is sent at a border between period A and period B. Furthermore, according to stream type I, an ECM C is sent at a border between period B and period C. For a stream type II, an ECM D is sent at a border between period B and period C.

For ECMs to be available for trick-play at the correct moment, the ECMs may be stored in a separate file. In this file it may also be indicated to which period an ECM belongs (which part of the recorded stream). The packets in the MPEG stream file may be numbered. The number of the first packet of a period (SCB toggle 1402) may be stored alongside with the ECM for this same period 1403. The ECM file may be generated during recording of the stream.

The ECM file is a file that may be created during the recording. In the stream, ECM packets may be located which may contain the Control Words needed to decrypt the video data. Every ECM may be used for a certain period, for instance 10 seconds, and may be transmitted (repeated) several times during this period (for instance 100 times). The ECM file may contain every first new ECM of such a period. The ECM data may be written into this file, and may be accompanied by some metadata. First of all, a serial number (counting up from 1) may be given. As a second field, the ECM file may contain the position of the SCB toggle. This may denote the first packet that can use this ECM to correctly decrypt its content. Then the position in time of this SCB toggle may follow as the third field. These three fields may be followed by the ECM packet data itself.

Using the SCB toggles stored in the ECM file, it may be easy to detect if such toggle is crossed even if this would be during a jump. To send the correct ECM, it may be required to know whether the ECMs contain one or two CWs. In principle, this is not known because it is provider-specific and secret. However, this can easily be determined experimentally by sending ECMs at various moments and observing the results on the display. An alternative method that is particularly suitable for implementation in the storage device itself is as follows. Send one single ECM to the smart card at the moment of an SCB toggle, decrypt the stream and check for PES headers in the coming two periods. With one PES header per GOP, there are around twenty PES headers in each period. The position of a PES header may be easily detected because a PLUSI bit in the plaintext header of the packet may indicate its presence. If correct PES headers are only found during the first period (after the latency of the smartcard), the ECM contains one CW. If they are also found during the second period, it contains two CWs.

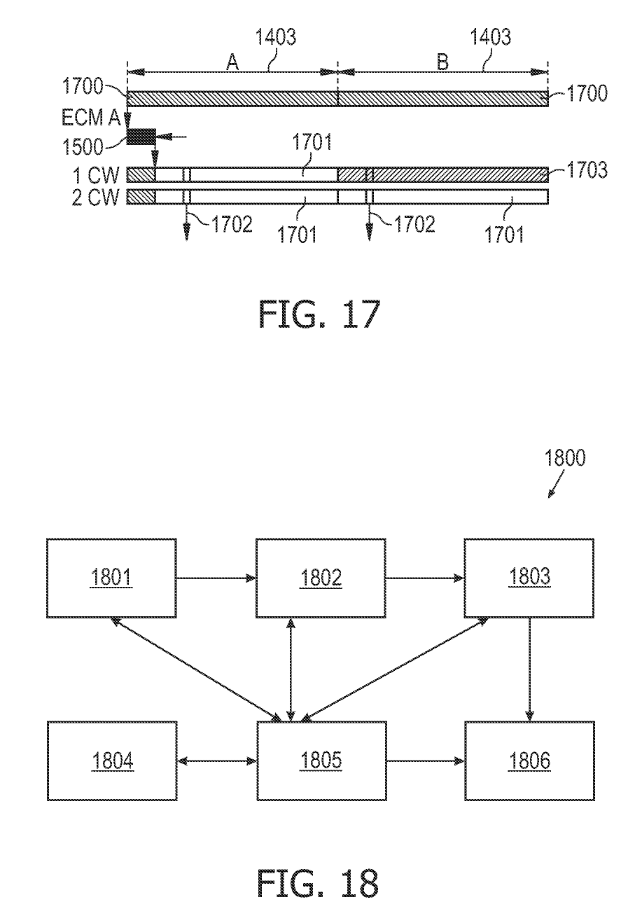

Such a situation is depicted in FIG. 17.

FIG. 17 illustrates a situation for one CW detection and for two CW detection. As can be seen, different periods 1403 of encrypted content 1700 are provided. With a smartcard latency 1500, an ECM A may be decrypted to generate corresponding CWs. By decrypting the encrypted content 1700, decrypted content 1701 may be generated. Further shown in FIG. 17 are PES headers 1702, namely a PES header A in period A (left) and a PES header B in period B (right).

The area 1703 of period B for one CW in FIG. 17 indicates that the data is decrypted with the wrong key and therefore scrambled. This checking could be done while recording, in which case it will take for instance 20 to 30 seconds. It could also be done off-line and, because only two packets indicated by the PLUSIs (one in each period) would have to be checked, it could be very quick. In the unlikely event that adequate PES headers are not available, the picture headers could be used instead. In fact, any known information may be useable for detection. Anyway, a one/two CW indication may be stored in the ECM file.

In the following, some aspects related to dealing with slow-forward streams in particular will be described.

Next, trick-play GOP based slow-forward, still picture and step mode will be explained.

Slow-forward which may also be denoted as slow motion forward is a mode in which the display picture runs at a lower than normal speed. One form of slow-forward is already possible with the technique explained above referring to FIG. 7 and FIG. 8. Setting the fast-forward speed to a value between zero and one results in a slow-forward stream based on a repetition of fast-forward trick-play GOPs. For a plaintext stream, this is a proper solution, but for an encrypted stream it may lead to the erroneous decryption of a part of the I-frame in certain specific conditions. One option to solve this problem is not to repeat the fast-forward trick-play GOP but to extend the size of the trick-play GOP by the addition of empty P-frames. This technique in fact may also enable slow-reverse, because it is based on the trick-play GOPs used for fast-forward/reverse and therefore on the independently decodable I-frames.

Such an I-frame based slow-forward or slow-reverse may be inappropriate in special cases for the following reason. The distance between I-frames in normal play is around half a second and for slow-forward/reverse it is multiplied with the slow motion factor. So this type of slow-forward or slow-reverse is not exactly what is usually understood as the slow motion but in fact more like a slide show with a large temporal distance between the successive pictures.

In a still picture mode, the display picture may be halted. This can be achieved by adding empty P-frames to the I-frame for the duration of the still picture mode. This means that the picture resulting from the last I-frame is halted. When switching from normal play to still picture, this can also be the nearest I-frame according to the data in the CPI file. This technique is an extension of the fast-forward/reverse modes and results in nice still pictures especially if interlace kill is used. However, the positional accuracy is not always satisfactory when switching from normal play or slow-forward/reverse to still picture.

The still picture mode can be extended to implement a step mode. The step command advances the stream to some next or previous I-frame. The step size is at minimum one GOP but can also be set to a higher value equal to an integer number of GOPs. Step forward and step backward are both possible in this case because only I-frames are used.

For the construction of a slow-forward stream many considerations apply. For example, the construction of a slow-forward stream on elementary stream level can only be performed on fully plaintext data. As a consequence, the slow-forward stream will be fully plaintext, even if the normal play stream was originally encrypted. Such a situation may be unacceptable to a copyright holder. Furthermore, this is worse than in the case of fast-forward/reverse stream because all information, i.e. each and every frame, is present in plaintext in the slow-forward stream and not just a subset of the frames as is the case for true fast-forward/reverse streams. Therefore a plaintext normal play stream can easily be reconstructed from a plaintext slow-forward stream. So the slow-forward stream should be encrypted if the normal play stream is encrypted. Since a DVB encryptor is not permissible in a consumer device this can only be realized if the slow-forward stream is constructed on transport stream level using the encrypted data packets from the originally transmitted encrypted data stream.

In the following, referring to FIG. 18 to FIG. 57, systems will be described which are capable of processing a data stream in a system according to exemplary embodiments of the invention.

It is emphasized that the systems described in the following can be implemented in the frame of and in combination with any of the systems described referring to FIG. 1 to FIG. 17.

In the following, referring to FIG. 18, a data processing device 1800 for processing an MPEG2 data stream according to an exemplary embodiment of the invention will be described.

The data processing device 1800 comprises a hard disk 1801 or any other storage device storing (for instance audiovisual) content to be reproduced. This content may be supplied to a processing unit 1802 for processing the data stream for subsequent reproduction, for instance in accordance with a trick-play reproduction mode or a normal-play reproduction mode. The output of the processing unit 1802 may be supplied to a timing unit 1803 for generating or correcting a timing information related to the data stream to be played back. The output of the timing unit 1803 may be supplied to a reproduction unit 1806 for reproducing the content, that is for playing back the content in an audiovisual manner.

A human user may control the operation of the data processing device 1800 via a user input/output unit 1804 via which the user may communicate with a control unit 1805. The control unit 1805 can communicate with each of the components of the system 1800.

Particularly, the device 1800 may process an input video data stream comprising a sequence of video frames. The processing unit 1802 may generate an output data stream as a trick-play stream, for instance a slow-forward stream, comprising a sequence of output frames based on the input data stream and based on a predetermined trick-play factor of, for instance, 3. Therefore, the processing unit 1802 may simply process the data stream originating from the hard disk 1801 to play back this data in a normal play reproduction mode or may play back the data in a trick-play reproduction mode, like slow-forward, stand still or slow-backward.

For a slow-forward reproduction mode, different frames originating from the hard disk 1801 have to be played back several times (in the case of B-frames) or have to be stuffed with empty frames (in the case of I-frames, P-frames) by the processing unit 1802. However, when the reproduction mode is changed from a normal play mode to a trick-play mode, it may be necessary to correct or adjust the timing information related to the data stream. Therefore, the timing unit 1803 may assign or correct timing information to the output frames, said timing information being based on original timing information of the sequence of input frames.

Particularly, the timing unit 1803 may assign timing information to the output frames, the relative timing information of the output frames being identical to the relative timing information of the sequence of input frames.

In the described embodiment, it is not the timing information (like DTS) itself that is kept identical, but the distance between the first packet of the frame and the DTS for that frame. The DTS is still just timing information and not the relative timing information. Both DTS and recording timestamp may be adjusted, but in such a way that their time difference does not change.

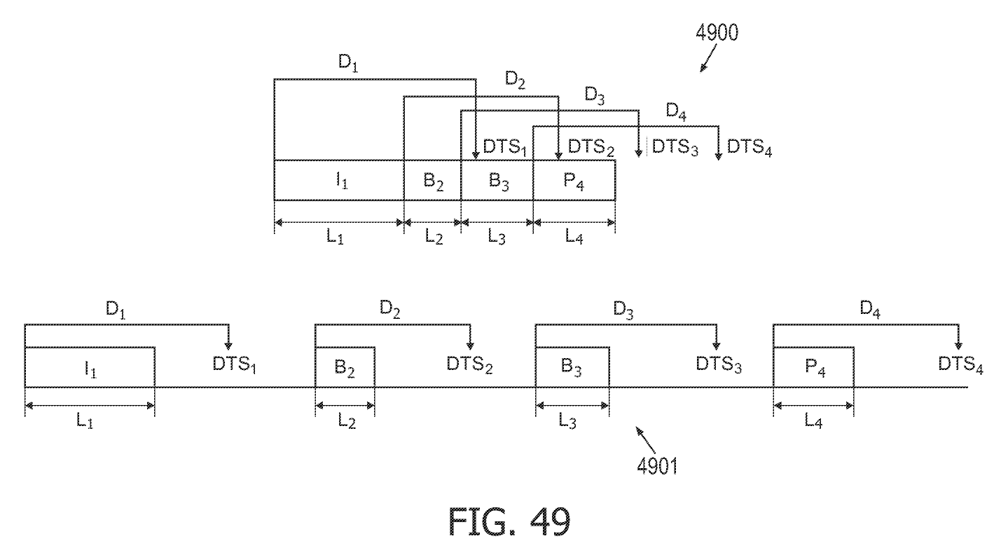

In the context of the functionality of the timing unit 1803, Decoding Time Stamps (DTS) may be assigned as the timing information to the output frames. The timing unit 1803 may assign the timing information to the output frames such that a distance between a start of an output frame and the corresponding Decoding Time Stamp is identical as compared to a start of an input frame and the corresponding Decoding Time Stamp. This will be explained in more detail below referring to FIG. 49. Beyond this, the timing unit 1803 may insert timing packets in the sequence of the output frames at a position between subsequent output frames to be reduced for the first time. Such a timing packet may be a Program Clock Reference.

The modified timing packet may be corrected with respect to a timing packet of the sequence of input frames. When processing an MPEG2 data stream, the data processing device 1800 may repeat B-frames several times (for instance 3 times when the trick-play factor is 3), and anchor frames like I-frames and P-frames may be repeated by using empty frames so as to achieve a reproduction according to a predetermined or preselected trick-play rate. A user operating the interface unit 1804 may select a reproduction mode, and may switch between a normal play mode and a slow-forward reproduction mode.

In the following, further details concerning the slow-forward trick-play reproduction according to exemplary embodiments of the invention will be explained.

Next, splitting of the stream into separate frames will be explained.

To be able to construct a slow-forward stream on transport level it is advantageous that each individual frame is available as a series of transport stream packets. In case of one PES packet per frame this comes natural. A PES packet is contained in a series of transport stream packets because PES and transport stream packets are aligned. In the case of one PES packet per GOP this is only the case for the start of the I-frame. All other frame boundaries are mostly located somewhere inside a packet. This packet contains information from the two frames. So first this packet may be split up into two packets, the first one containing the data from the first frame and the second one of the data from the next frame. Each of the two packets resulting from the splitting may be stuffed with an Adaptation Field (AF).

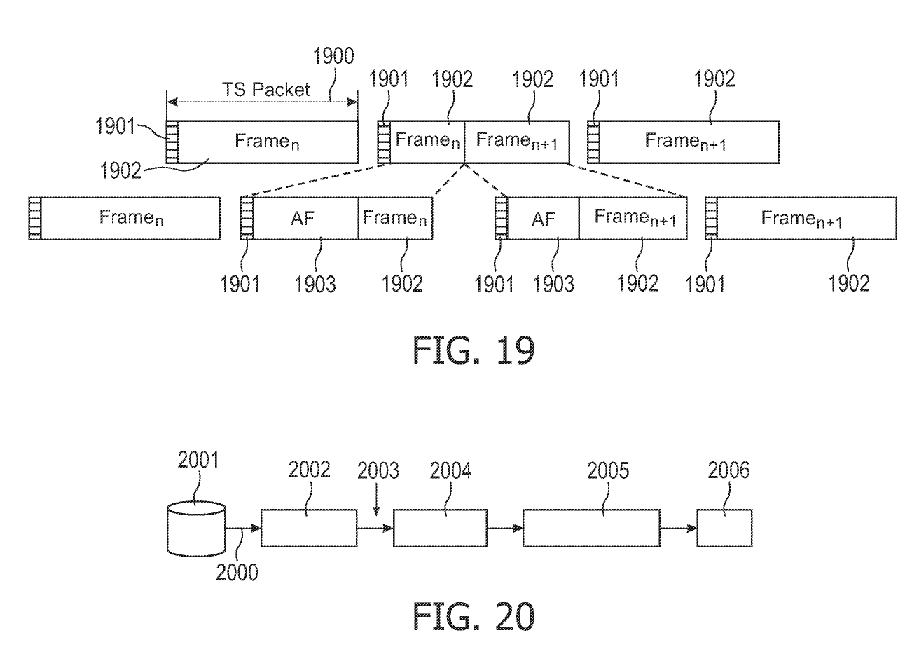

This situation is indicated in FIG. 19.

FIG. 19 shows splitting of the packet at a frame boundary. Particularly, FIG. 19 illustrates a plurality of TS packets 1900 each comprising a header 1901 and a frame portion 1902. As can be taken from a central portion of the data stream shown in FIG. 19, a packet comprising a header 1901 and two subsequent frames 1902 is split up into two separate portions each having a separate header 1901 followed by an Adaptation Field 1903 and followed by the corresponding frame 1902.

The splitting of packets is not difficult for a plaintext stream. A first option is to fully decrypt the normal play data as depicted in FIG. 20. FIG. 20 shows a slow-forward construction after decryption of normal play data. Encrypted normal play data 2000 from a harddisk 2001 are supplied to a decrypter 2002 generating a plaintext stream 2003. The plaintext stream 2003 is supplied to a frame splitting unit 2004 for splitting the different frames in a manner as shown in FIG. 19. Then, this data is supplied to a slow-forward construction unit 2005 constructing a slow-forward stream, which is then supplied to a set top box 2006.

The decryption and slow-forward mode of a stored fully encrypted stream 2000 or a stored hybrid stream is not difficult because no stream data is skipped or duplicated in the stream by the decrypter 2002. The stored stream 2000 (fully encrypted or hybrid) is simply fed at a lower than normal rate through the decrypter 2002 which also means that there are no problems with embedded ECMs (Entitlement Control Messages). The plaintext stream 2003 coming from the decrypter unit 2002 can then be used to split the packets or in fact to perform any necessary stream manipulation in the frame splitting unit 2004. The resulting slow-forward stream is a plaintext stream in this case.

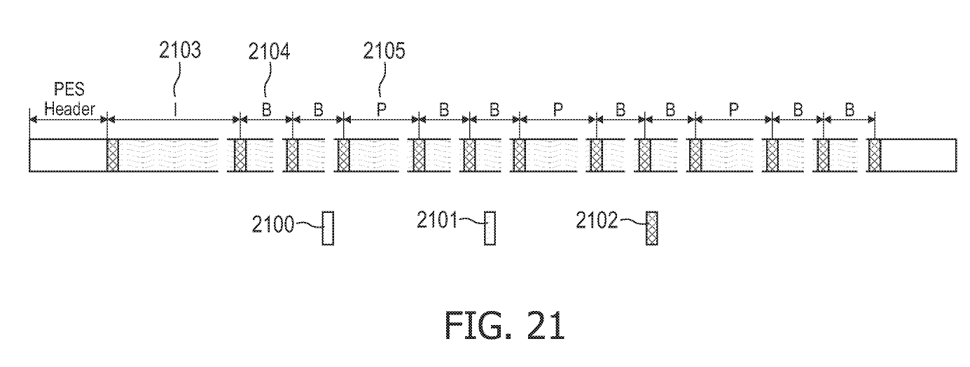

The construction of an encrypted slow-forward stream from an encrypted normal play stream is performed on transport level because the use of a DVB (Digital Video Broadcasting) encryptors and in consumer device may not be allowed in special cases. For this, a hybrid stream (see FIG. 21) with only a few plaintext packets 2100 and 2102 on all frame boundaries are needed. FIG. 21 furthermore shows encrypted packets 2101 which belong to the I-frames 2103, B-frames 2104 or P-frames 2105.

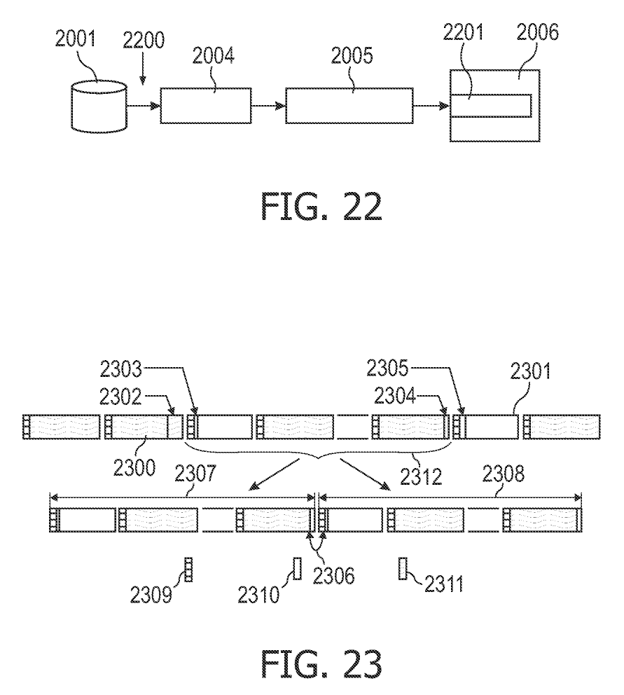

Below, it will be described how such a stream could be generated on the playback side of the storage device if the stored stream is fully encrypted. In this case, the decrypter unit 2002 in FIG. 20 may be a selective type that only decrypts the necessary packets. But preferably the stream is already stored as a hybrid stream as indicated in FIG. 22.

FIG. 22 illustrates slow-forward construction on a stored hybrid stream 2200. In the array shown in FIG. 22, no decryption unit 2002 is foreseen between the harddisk 2001 and the frame splitting unit 2004. However, a decrypter unit 2201 may then be foreseen in the set top box 2006.

The plaintext packets 2100, 2102 in the hybrid stream should now also allow for the splitting of packets containing data from the two frames. This may be guaranteed by a criteria which will be described below in more detail. However, some part of the sequence header code or picture start code can still be located in an encrypted packet. In this case, an ideal splitting is not easily possible. In fact the split may be made between the encrypted and plaintext packets. Solutions for these problems will be described below in more detail. In that situation only empty P-frames are concatenated to an I-frame and vice versa. For a frame based slow-forward, also other types of concatenation may be considered among which the concatenation of B-frames to B-frames. This may result in some kind of gluing algorithm at these frame boundaries as will be clarified referring to FIG. 23.

FIG. 23 illustrates a data stream in which a previous frame 2300, a current frame 2312 and a next frame 2301 are shown. At the end of the previous frame 2300, three bytes of picture start code 2302 are provided. Furthermore, at the beginning of the current frame 2312 one byte of picture start code 2303 is foreseen. Coming now to the next frame 2301, the frame end of the packet before comprises one byte of picture start code 2304. At the beginning of the next frame 2301, three bytes of picture start code 2305 are provided. FIG. 23 shows that an incomplete picture start code may be present at the concatenation point. This may make a gluing necessary at a connection region 2306. Thus, gluing should be performed between the B-frame 2307 and a repetition of the B-frame 2308.

FIG. 23 particularly illustrates a packet header 2309, plaintext data 2310 and encrypted data 2311. In the example of FIG. 23, there is only one byte of the picture start code at the start and the end of the B-frame. As a result, two bytes are missing at the concatenation point. The gluing algorithm, which will be described below in more detail may heal such a problem. For this gluing it should be known how the picture start code is split. This information may be obtained with a method that will be described below in more detail.

In the following, repetition of the frames will be described in more detail.

In a slow-forward mode, the decoder has somehow to be forced to repeat the display of a picture in accordance with the slow-forward factor. Empty P-frames may be used to force the repetition of a picture resulting from an I-frame. This technique can also be applied for pictures resulting from P-frames. However, this technique cannot be easily applied for B-frames because empty P-frames always point to an anchor frame being an I-frame or a P-frame. This is in fact the case for any type of empty frame. So the repetition of a picture resulting from a B-frame has to be realized in another way. A possible method is to repeat the B-frame data itself. Since the repeated B-frames point to the same anchor frames as the original B-frame the resulting pictures will be identical. The amount of data for a B-frame is usually much more than for an empty P-frame but in general it is still significantly less than for an I-frame. Anyway, the transmission is also multiplied with the slow-motion factor so there need not be an increasing bit rate at least on average.

The empty frames used to force the repetition of pictures resulting from an I-frame or a P-frame can be of the interlace kill type thus reducing interlace artefacts for these pictures. But such a reduction is not easily possible for pictures resulting from the B-frames because the repetition is not forced by an empty frame but the repetition of the B-frame data itself. So the B-frames will have the original interlace effects. If interlace kill would be used for the I-frames and P-frames this might look very awkward because pictures with and without interlace effects are sequentially present in the stream of displayed pictures. It is presently believed that it might be better to only use empty frames without interlace kill to construct the slow-forward stream.

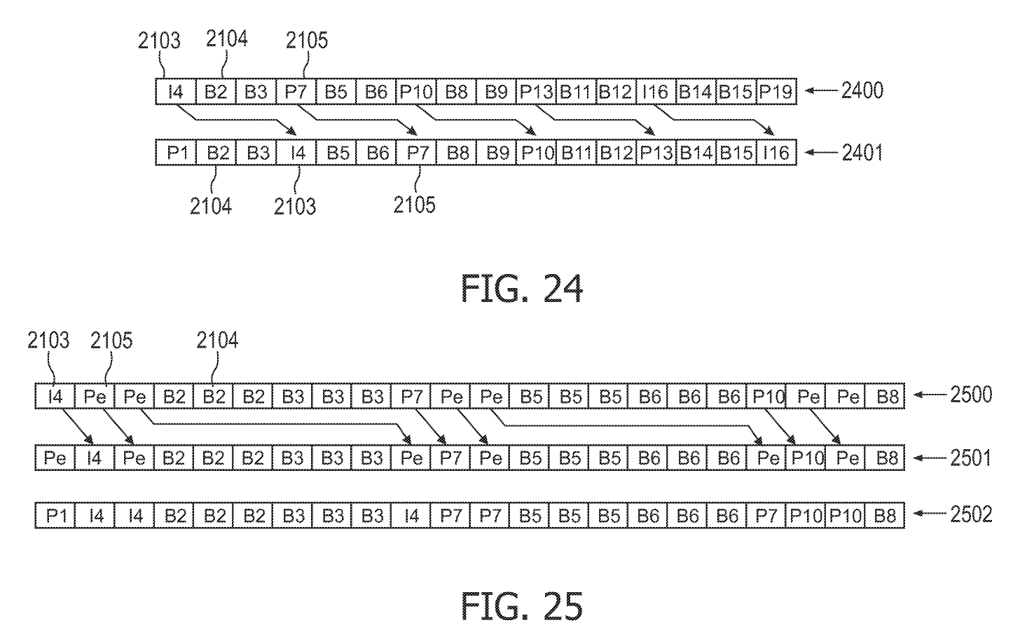

The repetition of the I- and P-frames may be enforced by the insertion in the transmission stream for empty P-frames after the original I-frame or P-frame. Such a method may be used for the fast forward/reverse stream comprising I-frames followed by empty P-frames. However, this method may be not absolutely correct for a stream that also includes B-frames, as in the case for a slow-forward stream constructed from a stored transmission stream with B-streams. Due to the reordering from transmission data to display stream, the I-frames and P-frames will be repeated in the wrong position thus disturbing the normal display order of the frames. This is illustrated in FIG. 24 and FIG. 25.

FIG. 24 illustrates the effect of reordering in normal play. FIG. 24 shows a transmission order 2400 and a display order 2401. Particularly, FIG. 24 depicts the effect of reordering in normal play. The top line shows a normal play transition stream 2400 with a GOP size of 12 frames comprising I-frames 2103, P-frames 2105 and B-frames 2104. The first four frames of the next transmission GOP are also shown for clarity. The bottom line of FIG. 24 shows the stream 2401 after reordering to the display order. The index indicates the display frame order. According to the MPEG2 standard ISO/IEC 13818-2: 1995(E) (see particular pages 24 and 25), the reordering may be performed as follows:

B-frames keep their original position;

Anchor frames (that is I-frames and P-frames) are shifted to the position of the next anchor frame.

FIG. 25 shows the effect of reordering in slow-forward mode. Particularly, FIG. 25 illustrates the transmission order 2500, an order after the reordering 2501 and an order of the displayed pictures 2502. Looking at the slow-forward stream constructed from the normal play stream in more detail, the top line of FIG. 25 shows the transmission order 2500 of the first part of the slow-motion stream for this case, assuming a slow-motion factor of three. Empty P-frames may be inserted after the I-frames and the P-frames, and the B-frames may be repeated. The middle line of FIG. 25 shows the effect of the reordering. The bottom line of FIG. 25 shows how the I-frames and the P-frames are repeated by the empty P-frames in this case. An empty P-frame may result in a display picture that is a copy of the picture resulting from the previous anchor frame, which itself could also be an empty P-frame. It is visible in FIG. 25 that the normal display order 2502 indicated by the index is disturbed because the display of frame 14 is split up into two parts. Only the last time frame 14 is displayed in the correct position. This also means that the B-frames may be decoded erroneously.

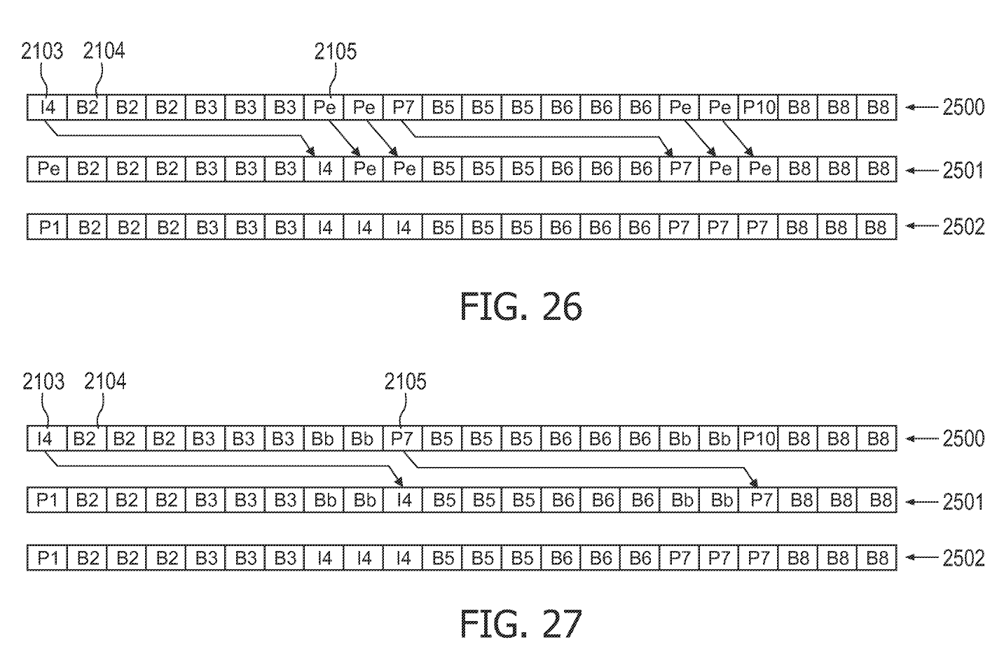

In the following, several options will be described how to correct such deficiencies. One possibility is shown in FIG. 26. FIG. 26 shows the insertion of empty P-frames before the anchor frames. The three rows in FIG. 26 are similar to the three lines of FIG. 25. In FIG. 26, the empty P-frames are inserted before the anchor frames in the transmitted stream extracted from the storage device as is shown in the top line 2500. In the reordered stream 2501, the empty P-frames are now positioned after the anchor frames. This is where they should be for a correct repetition of the anchor frames as is clear from the display pictures 2502 of FIG. 26.

However, there are arguments why it may be appropriate to avoid empty P-frames. One is related to the propagation of errors within a GOP. P-frames depend on the previous anchor frame and B-frames depend on the surrounding anchor frames. A data error during the transfer to the set top box results in coding errors and therefore disturbances in the picture. If this error is an anchor frame it propagates until the end of the GOP because subsequent P-frames depend on this anchor frame. Also the B-frames are affected because they use the pictures from the disturbed surrounding anchor frames for the decoding. This may have the consequence that the picture disturbances gradually increase towards the end of the GOP. This may be especially important for slow-forward where the GOP size can be very large and therefore very long in time. On the other hand, a data error in a B-frame has only a very limited effect because no other frames depend on it. So the picture disturbances are restrained to this B-frame and its repetitions. One might argue that data errors should not occur on a digital interface but there may be a second advantage in preventing the use of empty P-frames. If these are of the interlace kill type they change at the decoded picture by nature resulting in decoding errors for the subsequent frames. So interlace kill may be not possible.

Referring to the construction of empty frames, several types of empty B-frames can be constructed. They may have the advantage that no additional error propagation is introduced and that interlace kill can be used.

Possible types of empty B-frames are the forward predictive empty B-frames (which may be denoted as Bf frames) and backward predictive empty B-frames (which may be denoted as Bb frames).

A B-frame is normally bi-directionally predictive, but uni-directional predictive B-frames can also exist. In the latter case they can be forward or backward predictive. Forward predictive means that an anchor frame is used to predict the following B-frames during encoding. So the picture resulting from a forward predictive B-frame is reconstructed during decoding from the previous anchor frame. This means that the Bf-frame forces the repetition of the previous anchor frame. Therefore, it has the same effect as an empty P- or Pe-frame. The Bb-frame has the opposite effect. It forces the display of the anchor frame following it. For both types of empty B-frames, an interlace kill version is possible as well.

In the following, it will be described how to use such empty B-frames for the construction of a slow-forward stream.

A first possibility on the basis of Bb-frames is depicted in FIG. 27.

The Bb-frames are inserted before the anchor frames and keep their position during the reordering. The anchor frames are shifted to the position of the next anchor frame. The Bb frame forces the display of the anchor frame following it in the reordered stream.

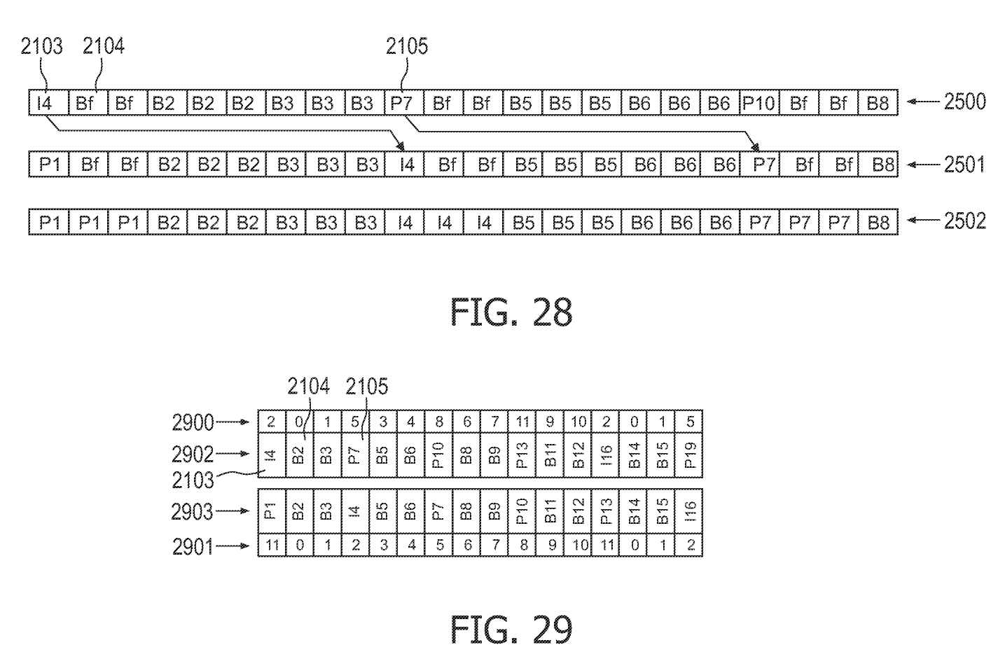

Another option is the use of Bf-frames as shown in FIG. 28.

The Bf-frames are inserted after the anchor frames in the transmission stream. The repeated display of the anchor frames in the reordered stream is forced by the Bf-frames that follow them.

The use of Bf-frames is similar to the use of empty P-frames for the construction of fast-forward and fast-reverse streams. In fact the use of Bf-frames is also possible in that case thus commonising the trick-play generation even further. But when Bf-frames are used for fast-forward and fast-reverse, the effect of reordering should be considered. This means that some parameters in the fast-forward/reverse stream like PTS/DTS and temporal reference have to be chosen appropriately.

In the following, further details concerning the temporal reference will be explained.

The display order within the transmission GOP starting with a GOP header is indicated by the temporal reference in each picture header. The first frame to be displayed has a temporal reference equal to zero. This is depicted in FIG. 29 for a normal play stream.

FIG. 29 illustrates a temporal reference 2900 for the transmission order 2902 and illustrates a temporal reference 2901 for a display order 2903.

In display order 2903, the temporal references 2901 are a monotonously increasing series from 0 to 11. Due to the reordering, the temporal references of the anchor frames in the transmission stream are shifted.

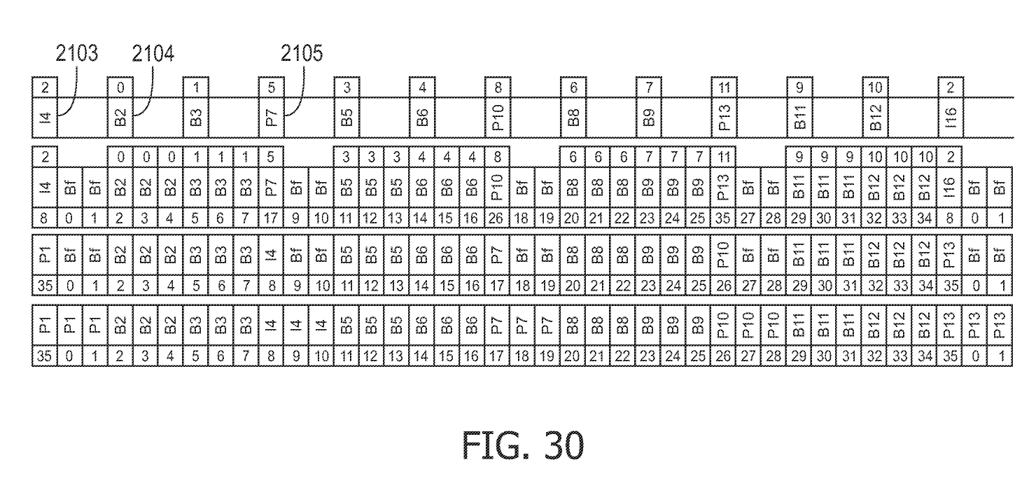

Considering the temporal references in the case of a slow-forward stream, the situation for the preferred case that the Bf-frames are inserted is depicted in FIG. 30 for a slow motion factor of three.

FIG. 30 indicates the temporal reference for slow-forward with Bf-frames.

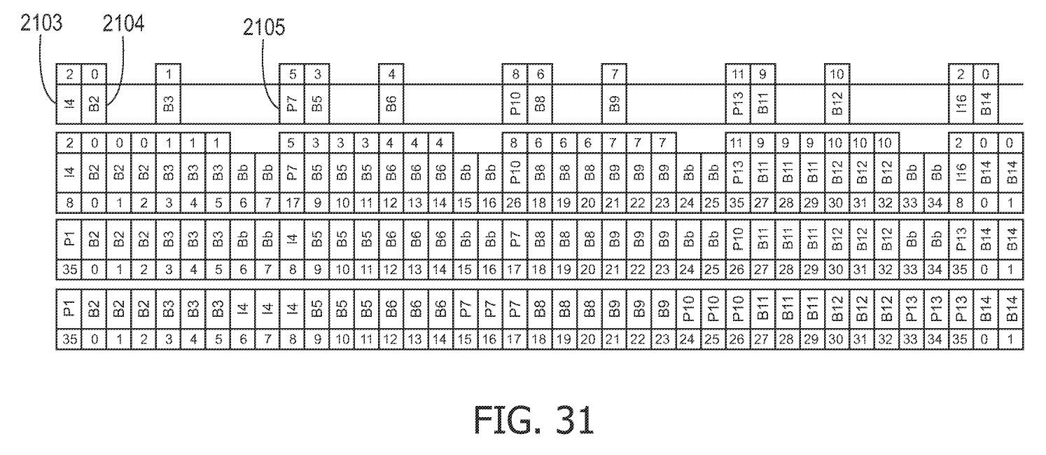

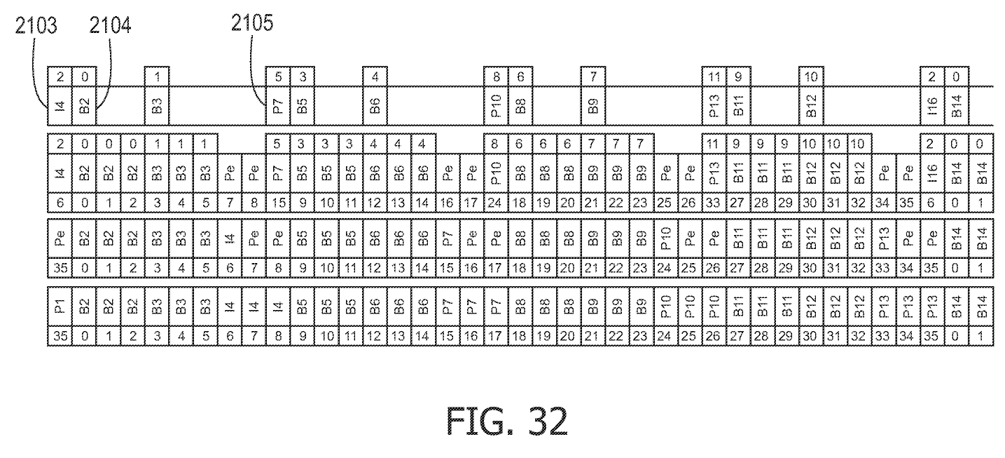

The top line of FIG. 30 indicates the frames taken from the normal play stream shown in FIG. 29 with the original temporal references. The second line of FIG. 30 shows the insertion of Bf-frames and the repetition of the B-frames. The original temporal references are shown above this line and how they should be below this line. The third line of FIG. 30 shows the frames after reordering, and the bottom line of FIG. 30 shows the displayed pictures. The temporal references of the reordered frames are shown below these lines. It forms an increasing series from 0 to 35. The temporal references in the case of pre-insertion of B-frames or Pe-frames are depicted in FIG. 31 and in FIG. 32 for comparison.

It can be taken from FIG. 30, FIG. 31 and FIG. 32 that the frames of the slow-forward stream should be provided with new temporal references. How these are derived is explained hereinafter. It should be mentioned that in theory a GOP does not need to be preceded by a GOP header. Although a GOP without GOP header has not been encountered in practice, this situation will also be considered. The temporal reference is only reset to zero for the first displayed frame after a GOP header. So in the absence of a GOP header the temporal reference will not be reset to zero but increased to its maximum value of 1023 and then return to zero. In this case, the I-frame has to be treated in the same way as the P-frame and the B-frame following an I-frame as a B-frame following a P-frame. All calculations are performed on a modulo 1024 basis. For the generation of new temporal references, a distinction is made between the new temporal references for the B-frames and for the anchor frames.

In the following, new temporal references for the B-frames will be described.

No distinction is here made between original B-frames, repeated B-frames or inserted empty B-frames. But another categorization of the B-frames is made in relation to the temporal reference.

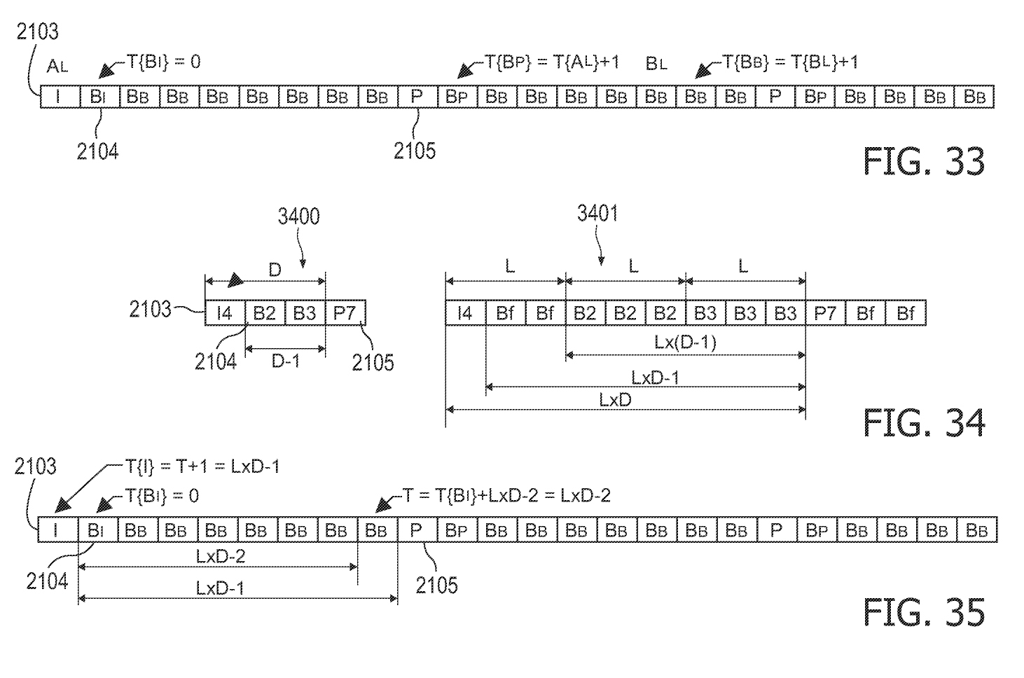

FIG. 33 shows an example for the case that Bf- or Bb-frames are inserted (note that B_{B} is not Bb). In general, three types of B-frames are distinguished:

1. B-frames Following an I-frame (B_{I}).

This is always the first frame to be displayed of the current transmission GOP. If no GOP header is present, it is treated as a B-frame following a P-frame. When a GOP header is present, the temporal reference in this B-frame is zero:

T{B_{I}}=0 (5)

2. B-frames Following a P-frame (B_{P}).

Due to the reordering, this B-frame is displayed after the last anchor frame preceding the P-frame in the transmission stream in front of this B-frame. This last anchor frame is denoted by A_{L} and can be an I-frame, a P-frame or an empty P-frame. In this case, the temporal reference of the B-frame is equal to the temporal reference of the last anchor frame A_{L} increased by 1:

T{B_{P}}=T{A_{L}}+1 (6)

3. B-frames Following Another B-frame (B_{B}).

It is displayed after the preceding B-frame (B_{L}) in the transmission stream, which can also be an empty B-frame.

In this case, the temporal reference of the B-frame is equal to the temporal reference of the preceding B-frame increased by 1:

T {B_{B})=T {B_{L}}+1 (7)

Next, new temporal references for the anchor frames will be described.

Due to the reordering, the anchor frames will be displayed after the sequence of B-frames following them in the transmission stream. So it is important to know how many B-frames will follow the I-frames and P-frames in the slow-forward stream to determine their new temporal reference. In the case of a varying GOP size or of a varying GOP structure this cannot be derived from history. In practice, a varying GOP structure is not common. Even for stations having a varying GOP size, the anchor frames will always be followed by the same amount of B-frames. Nevertheless, a varying GOP structure will be considered and is possible.

To be able to handle a varying GOP structure, the number of B-frames that will follow an individual anchor frame in a transmitted slow-forward stream has to be determined. This can be calculated from the slow motion factor and the number of B-frames following this anchor frame in the original recorded stream, taking into account whether empty B-frames or empty P-frames are inserted. So this number of B-frames is determined somehow. A possibility how this can be performed is to read all the data up to the next anchor frame but this demands for a substantial amount of buffering. Another possibility avoiding this buffering is to store this information in the CPI file and extract it from there. The number of B-frames can be easily derived from the distance in frames to the next anchor frame in the transmitted stream. In fact it is equal to this distance minus one. There are two ways to store this information in the CPI file:

1. The CPI file holds an entry for each frame including its type;

2. The CPI file holds an entry for each anchor frame that includes the distance in frames to the previous anchor frame.

In the first case, the distance in frames to the next anchor frame can easily be counted in the CPI file. The second case may seem a bit strange because the distance of the previous anchor frame is stored with the frame instead of the distance to the next anchor frame. This is chosen because the distance of the previous anchor frame is known at the moment that an anchor frame is received. The distance from the current anchor frame to the next anchor frame is simply found by reading the distance information from the next anchor frame in the CPI file. This distance will be denoted by D and the slow motion factor will be denoted by L, both of which being an integer larger than zero (see FIG. 34).

FIG. 34 shows the distance D and the slow motion factor L for normal play 3400 and for slow-forward play 3401.

The factor L is therefore not the speed factor but the slow down factor.

The total number of B-frames following the anchor frame depends on the insertion of empty B-frames or P-frames. So it is distinguished between two situations, namely that empty B-frames (Bf or Bb) or empty P-frames (Pe) are inserted. In case no GOP header is present, the I-frame is treated as a P-frame.

Next, the new temporal reference in case that empty B-frames (Bf or Bb) are inserted will be described.

The original distance to the next anchor frame is equal to D (see FIG. 34).

The distance to the next anchor frame in the slow-forward stream is equal to L×D.

So the total number of B-frames following the anchor frames is equal to L×D−1.

The first B-frame following an I-frame has a temporal reference of zero (see FIG. 35).

So the last B-frame following the I-frame has a temporal reference equal to L×D−2. The I-frame is the next one to be displayed, so its temporal reference is one higher. Then the temporal reference for the I-frames is given by:

T{I}=L×D−1 (8)

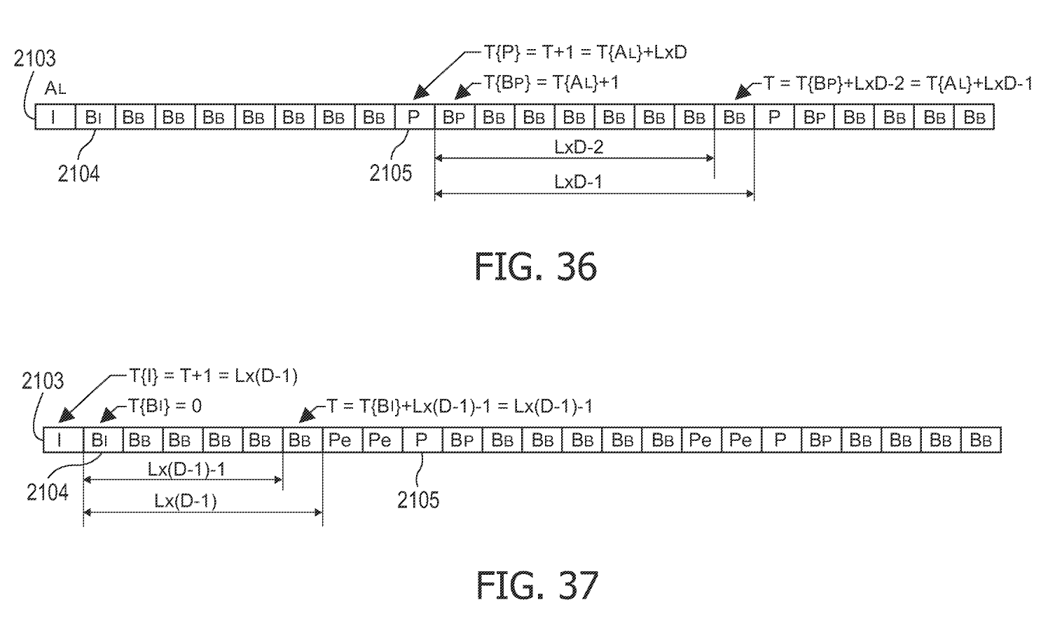

The temporal reference for the P-frame also depends on the temporal reference of the previous anchor frame and the slow-forward stream. This previous anchor frame (I-frame or P-frame) will be denoted by A_{L}, and its temporal reference is denoted by T {A_{L}} (see FIG. 36).

The B-frame following the P-frame will be displayed after the previous anchor frame A_{L}. So the temporal reference of this B-frame is equal to T{A_{L}}+1.

The temporal reference of the last B-frame following the P-frame is

T{A_{L}}+L×D−1.

The P-frame is the next one to be displayed so its temporal reference is one higher. Then the temporal reference for the P-frames is given by:

T{P}=T{A_{L}}+L×D (9)

In the following, it will be explained how the temporal reference is defined in case that empty P-frames (Pe) are inserted.

Since no empty B-frames are inserted, the total number of B-frames following an anchor frame is now L×(D−1) instead of L×D−1 (see FIG. 37).

The temporal reference for the I-frames is now given by:

T{I}=L×(D−1) (10)

A distinction is now made between P-frames and Pe-frames.

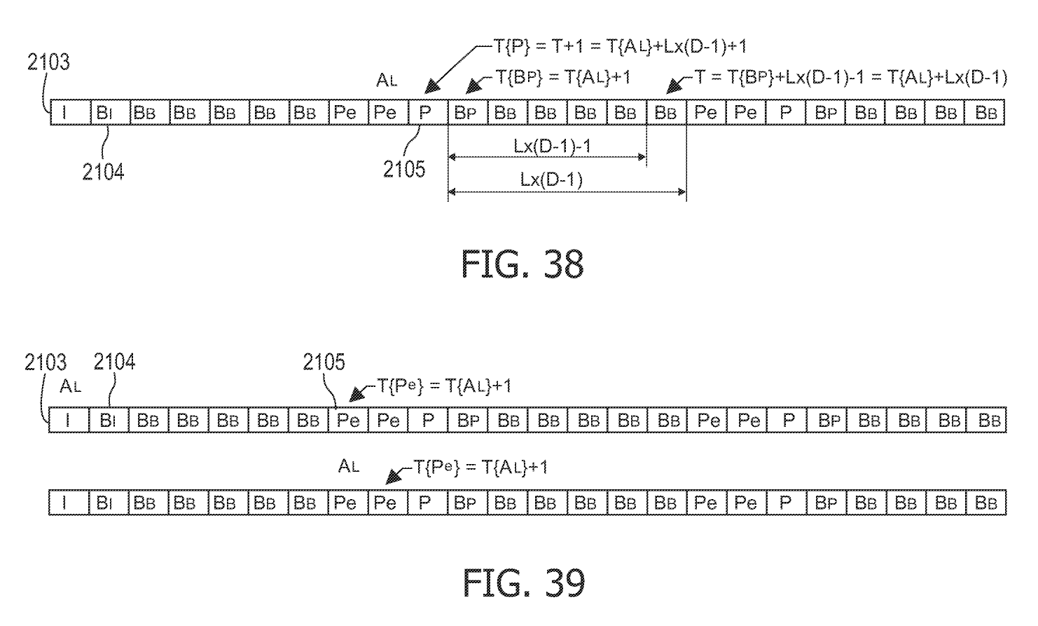

The anchor frame previous to the P-frame is normally a Pe-frame except for the case L=1 where it is an I-frame or P-frame. In any case the previous anchor frame will be denoted by A_{L} and its temporal reference by T{A_{L}}, see FIG. 38.

The temporal reference for the P-frames excluding the Pe-frames is now given by:

T{P}=T{A_{L}}+L×(D−1)+1 (11)

After the reordering, a Pe-frame will immediately follow a previous I-frame, P-frame, or Pe-frame, so a previous anchor frame. As a result, the temporal reference to the Pe-frame is always one higher than that of the previous anchor frame A_{L} (see FIG. 39).

The temporal reference for the Pe-frame can also be calculated with the formula for the P-frame by taking D=1. This results from the fact that a Pe-frame in the transmission stream is always followed by another anchor frame. It should also be noted that L=1 corresponds to normal play and results in a normal temporal reference in all cases.

Next, gluing of the individual frames will be described.

Particularly, the gluing of frames in the case of incomplete picture start codes will be discussed. In order to determine the required gluing activities at the concatenation point in the slow-forward stream, it should first be clear where the original stream is explicitly split into individual frames. In the following, the practical situation of one PES packet per GOP or per frame will be considered.

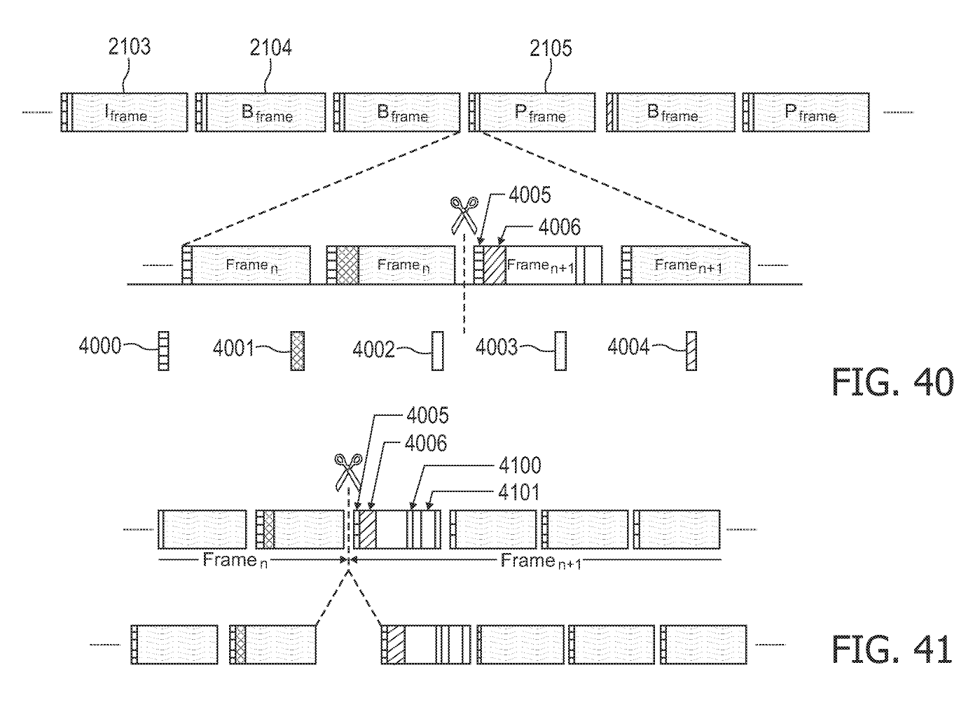

In the case of one PES packet per frame, the original stream may be split between the packet with the PLUSI and the preceding packet, as indicated in FIG. 40.

In FIG. 40, the splitting of the stream for one PES packet per frame is illustrated. The data streams shown in FIG. 40 include plaintext packet headers 4000, Adaptation Fields 4001, plaintext data 4002, encrypted data 4003 and plaintext PES header 4004. Furthermore, a PLUSI present is denoted with reference numeral 4005, and a PES header is denoted with reference numeral 4006.

The individual frames comprise a number of complete original packets. So no packet splitting is necessary. This frame splitting could also be performed in a completely encrypted stream, but access to some plaintext data is still necessary for the construction of the slow-forward stream. The splitting at the start of a packet with a PLUSI also means that there are no picture start codes that are spread over two packets. Each individual frame contains its own correct and complete picture start code. Therefore, no gluing activity is necessary in this case.

However, in the case of one PES packet per GOP, the situation is different. The split between frames is made at the picture start code of a new frame, unless a PES header precedes it.

The following algorithm may be used to determine the splitting point:

1. The original stream is simultaneously researched for a packet with a PLUSI bit set, a picture start code and a picture coding extension;

2. If the packet with the PLUSI bit set is encountered first, the split is made at the start of this packet (see FIG. 41, including a picture start code 4100 and a picture code extension 4101). Subsequently, the stream is searched for the picture coding extension. After this is found, the search is continued as described in point 1.;

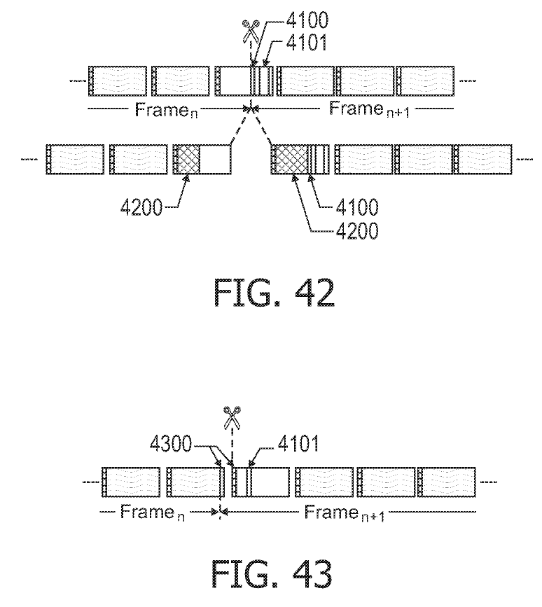

3. If the picture start code is encountered first, the split is made at the start of the picture start code. In many cases this means that the packet containing the picture start code has to be split in two packets of which the first is assigned to the previous frame and the second to the subsequent frame (see FIG. 42 illustrating splitting of a stream at the start of a picture start code 4100, wherein places of insertion of an Adaptation Field are denoted with reference numeral 4200). Both packets are stuffed with an Adaptation Field 4200. The payload of the second packet then starts with the picture start code 4100. The recording time stamp of the original packet is copied to each of the two packets resulting from the split. Whether the two packets from the split or the original packet will be used at a concatenation point of two frames depends on the specific situation as will be explained below. Subsequently, the stream is searched for the picture coding extension 4101. After having found this, the search is continued as described in point 1.;

4. If the picture coding extension is encountered first, the picture start code must be undetectable because it is partially encrypted. This means that the current plaintext area starts with some bytes of the picture start code. In this case the split is made at the start of the first plaintext packet of the current plaintext area (see FIG. 43 showing the splitting of the stream within a picture start code 4100, and illustrating bytes of picture start code 4300 as well as picture code extension 4101). The search which is described in point 1. is continued after having found picture coding extension 4101.

The described algorithm would also result in the correct splitting points for a stream with one PES packet per frame. Moreover, the algorithm is designed for application to plaintext streams as well as the hybrid streams mentioned above.

Gluing is only necessary in the case of incomplete picture start codes that can only result from point 4. of the given algorithm. So only point 4. leads to a non-ideal splitting point. A plaintext stream contains only ideal splitting points because the picture start code is always found. So no gluing is necessary in this case. But hybrid streams will contain non-ideal splitting points. A method described below may be used to determine how many bytes of the picture start code are on either side of the non-ideal splitting points. The effects of a non-ideal splitting point will be explained in detail hereinafter.

Next, the situation will be considered that empty P-frames of any type are inserted at such a non-ideal splitting point. How to handle the first empty frame will be explained below. A number of bytes equal to the part of the picture start code after the splitting point is removed from the picture start code of the first empty frame. The intermediate empty frames are unchanged. The last empty frame has to be corrected for the missing part of the picture start code of the subsequent frame. So this missing part may be added to the end of the last empty frame. No changes are necessary to empty frames that are inserted at ideal splitting points.

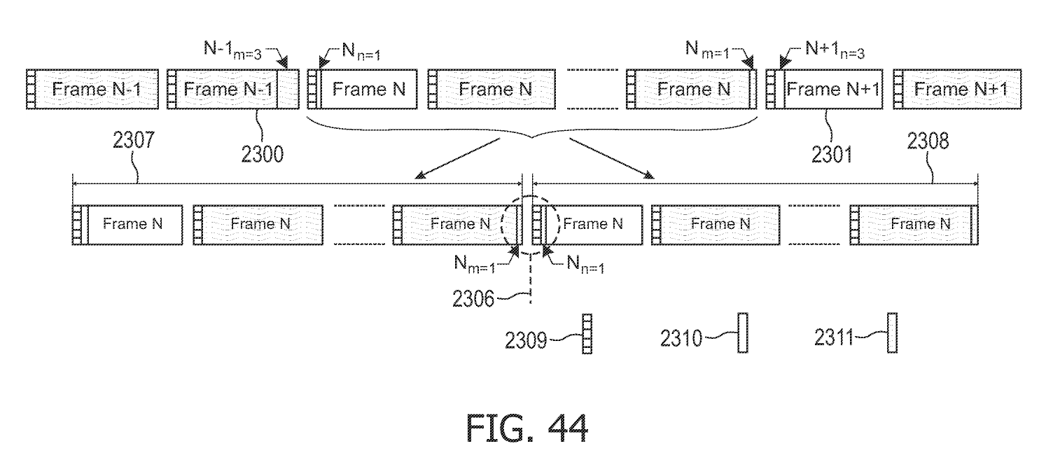

In the following, the repetition of the B-frames will be considered. In case the B-frame has ideal splitting points on both sides, no gluing action is necessary for the repetition. But if a non-ideal splitting point is present on either side of the frame, gluing actions may be necessary or advantageous. The original frame and its repetition form a series of identical B-frames. No gluing action is necessary at the start or end of the series because here the frame is either connected to the same frame as in the normal play stream or to an empty frame. In the first case there is no discontinuity because normal order of the data is restored at this point. The solution for the second case has been given above. So only the intermediate concatenation points have to be considered where the end of a B-frame is connected to the start of the same B-frame. The example described here refers to the example given above referring to FIG. 23 and is repeated in more detail in FIG. 44 for clarity.

FIG. 44 illustrates incomplete picture start code at the concatenation point.

For a correct gluing it is necessary to know the number of bytes of the picture start code (within MPEG2 the start code may be 4 bytes in length) at the end and the start of the B-frame. Denoting the number of bytes at the end by n and at the start by m, for an ideal splitting point n=0 and m=4. In the case of a non-ideal splitting point, the number n for one frame and the number m for the subsequent frame may be determined with a method which will be illustrated below.

It is evident that n can never be equal to 4 because then the split would have been made at the start of the picture start code resulting in n=0. On the other hand, m can never be 0 because in that case the picture start code would be completely in a previous frame and the split would have been made in the ideal position thus leading to m=4. So 0≦n≦3 and 1≦m≦4 is a usual situation.

In order to get the numbers n and m for one and the same frame N, these numbers have to be extracted from the information of the two splitting points surrounding the frame. So n and m now represent the number of bytes of the picture start code at the end and start of a B-frame that has to be repeated. As a consequence, they also represent a number of bytes of the picture start code before and after an intermediate concatenation point.

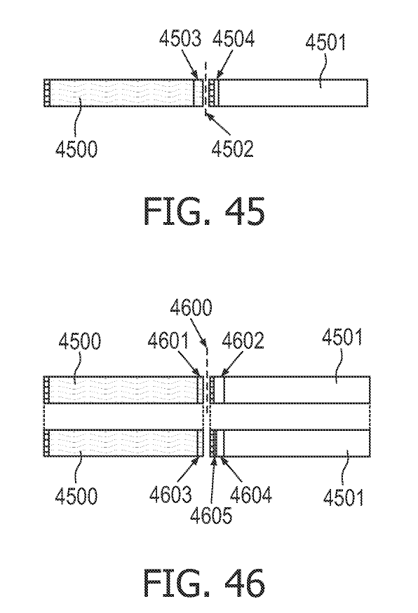

Next, it will be assumed that n+m=4. This is the case when both splitting points surrounding the B-frame are ideal. But it is already known that no gluing action is needed in that case. However, this can be also the case when both splitting points are non-ideal. This is the situation depicted in FIG. 45.

FIG. 45 therefore illustrates the example of n+m=4.

The last packet of frame N is denoted with reference numeral 4500, and FIG. 45 further shows the first packet of frame N denoted with reference numeral 4501. No gluing action is necessary at a border 4502. The bytes of the picture start code (n=3) is denoted with reference numeral 4503, and the byte of picture start code (m=1) is denoted with reference numeral 4504.

The fact that n+m=4 means that the correct amount of picture start code bytes are present at the concatenation point and that no gluing action is necessary.

However, FIG. 46 shows the situation with n+m>4.

This means that there are 1, 2 or 3 bytes too much at the concatenation point. In this case a number of bytes equal to n+m−4 is removed from the start of the second frame. This is accomplished by replacing these plaintext bytes by an Adaptation Field (AF) containing stuffing bytes. If an Adaptation Field is already present, its length has to be increased with m+n−4 and the data to be discarded is replaced by stuffing bytes that, according to the standard, have a hexadecimal value FF.

In the special cases of n+m>4 and n<3 it is also possible to do no gluing. Effectively, one gets elementary stream stuffing.

A point at which gluing action is necessary is denoted with reference numeral 4600. In the example, the bytes of picture start code (n=2) is denoted with reference numeral 4601. Bytes of picture start codes (m=3) are denoted with reference numeral 4602. Furthermore, bytes of picture start code (n=2) are denoted with reference numeral 4603 and bytes of picture start code (m=2) are denoted with reference numeral 4604. A position of replaced bytes using Adaptation Fields (n+m−4) is denoted with reference numeral 4605.

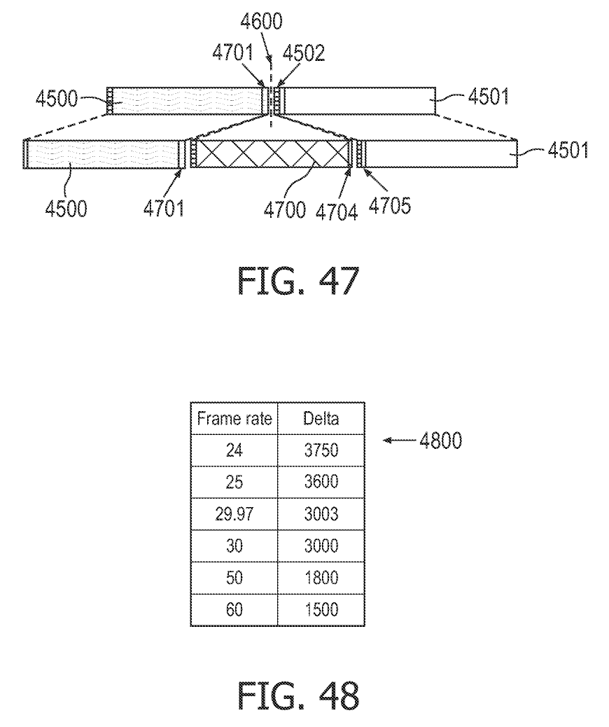

Referring to FIG. 47, it is assumed that n+m<4.

This means that 1, 2 or 3 bytes are missing from the picture start code at the concatenation point. In this case it should be known which byte or bytes are missing. Because n and m are both known, the missing bytes can be uniquely identified. The missing bytes are now placed in a new packet that is further stuffed with Adaptation Field. This gluing packet is then placed between the two frames. This gluing packet is denoted with reference numeral 4700. Reference numeral 4701 denote bytes of picture start code (n=2), reference numeral 4702 denote bytes of picture start code (m=1). Reference numeral 4704 denotes inserted bytes (4−n−m). Reference numeral 4705 illustrates bytes of picture start code (m=1).

In the following, DTS (Decoding Time Stamps) and PTS (Presentation Time Stamps) in the slow-forward stream will be explained.

This description includes the description of the generation of new DTS and new PTS values for all the frames in the slow-forward stream, so including repeated B-frames and empty frames. The given DTS and PTS formulas result in a continuous PTS in the display stream (so after reordering) when switching from normal play to slow-forward. A discontinuity in the display of frames at the switching point may thus be avoided. No additional DTS or PTS has to be inserted in the stream; only an existing DTS or PTS is replaced by a new value. The PES packet length may be changed to zero (unbounded) whatever its original value. In the case of one PES packet per GOP, an incorrect PES packet length at the switching point cannot be avoided if this value was other than zero, unless substantial buffering is used or the switch is delayed to the start of an I-frame. In practical broadcast streams, the PES packet length is mostly set to unbound (zero).

In the following, calculation of the a DTS value will be explained.

According to the MPEG-2 standard (ISO/IEC 13818-1: 1996(E), see particular pages 95 and 96), the DTS of frames with no DTS has to be calculated in the sequential way from the most recent frame with a DTS by means of the following formula:

DTS{F}=DTS{F_{L}}+Delta (12)

In formula (12), F designates the current frame and F_{L} the previous frame in the transmission stream. The existence of formula (12) can be easily understood. The stream is reordered with the purpose that the decoding order is identical to the transmission order. That the decoding of subsequent frames is separated by one frame time is obvious. These observations immediately lead to the given formula assuming that Delta is a DTS increment that corresponds to one frame time. Formula (12) may for instance be used in the case of one PES packet per GOP to successively calculate the DTS of all the frames and the GOP from the DTS of the I-frame. But this formula can also be used to easily derive the DTS of all frames in the slow-forward stream from the DTS of the last frame before the switching point.

The parameter Delta is equal to the number of 90 kHz periods in one frame time because the DTS is linked to the PCR base. Some values for Delta in dependence of the frame rate are given in FIG. 48.

Namely, FIG. 48 shows Delta as a function of the frame rate.

In the following, a calculation of PTS values will be explained.

According to the MPEG-2 standard (see page 34 of ISO/IEC 13818-1: 1996(E)), the PTS of a B-frame is given by:

PTS{B}=DTS{B} (13)

According to the same standard, the PTS for an anchor frame is given by:

PTS{A}=DTS{A} for a low_delay sequence (14)

PTS{A}=DTS{A_{N}} for a non-low_delay sequence (15)

In formula (15), A_{N} stands for the next anchor frame in the transmitted stream. A low_delay sequence is a stream without B-frames in which the low-delay_flag is set. In practice, streams without B-frames have been encountered, but not a low delay sequence.

For a non-low_delay sequence, the PTS may be expressed as a function of the DTS of the same frame. In the normal play stream, the distance to the next anchor frame is equal to D frames. The distance to the next original anchor frame in the slow-forward stream is increased by the slow-motion factor L to L×D frames. In the case that empty B-frames are used, no additional anchor frames are present in the slow-forward stream. Since DTS values increase by Delta from frame to frame, the following relation holds:

DTS{A_{N}}=DTS{A}+L×D×Delta (16)

Substitution of DTS{A_{N}} by PTS{A} leads to the following formula for the PTS of anchor frames in the case that empty B-frames are inserted:

PTS{A}=DTS{A}+L×D×Delta (17)

In the case of pre-insertion of empty P-frames, the distance of an original anchor frame to a next anchor frame, which is now an empty P-frame, is reduced by L −1 frames. The distance of an empty P-frame to the next anchor frame is always equal to one frame. The PTS of anchor frames in the case that empty P-frames are inserted is then given by:

PTS{A}=DTS{A}+[L×D−(L−1)]×Delta (18)

PTS{Pe}=DTS{Pe}+Delta (19)

In the case of one PES packet per GOP, only the DTS and PTS of the I-frame are replaced by the calculated values. No additional DTS/PTS have to be added to the stream. Although this may result in a violation of the maximum distance of 700 ms between two PTS values in the presentation stream, no problems are expected. The reason is that the DTS/PTS values of the total slow-forward stream are calculated according to the rules for missing DTS/PTS values. This means that no discrepancies should be present between the values calculated by the STB for the frames in the slow-forward stream and the actual DTS/PTS values. Since the calculated PTS is not used for any other purpose than the replacement of an original PTS, it only needs to be calculated for the I-frames in the case of one PES packet per GOP. The DTS has to be calculated for every frame though. First of all because the DTS of a frame is calculated from the DTS of the previous frame, but additionally because the old and new DTS of a frame are used in the following for the positioning of the data of this frame in the slow-forward stream.

Next, positioning of the frames and packets using time stamps will be explained.

This section deals with the placement of frames and packets on the time-axis of the slow-forward stream using the recording time stamps pre-pended to each packet. It starts with the placement of the original normal play frames. Then the repetition and compression of B-frames is described. Subsequently the placement of empty frames is explained. Finally, some issues around the PCRs are discussed.

In the following, positioning of the original normal play frames will be explained.

Decoding problems may occur if the decoding starts before the necessary data are received. Such a possible decoding problem may be avoided for the slow-forward stream if the distance of the end of the frame data to the DTS of this frame is identical for the slow-forward and the normal play stream. This may be achieved by keeping the distance at the start of the frame data to the corresponding DTS identical to the normal play stream and placing the packets of this frame with the same packet distance as from the original normal play stream.

This situation is depicted in FIG. 49 illustrating the unmodified distance to DTS. The distance to the DTS can be much larger than shown in FIG. 49.

FIG. 49 shows the situation in normal play which is denoted with reference numeral 4900 and shows the situation in slow-forward which is denoted with reference numeral 4901.

The starting moment of the frame data is given by the value of the System Time Counter at the start of this frame. This is designated by a virtual PCR value PCRS. The superscripts N and S designate respectively the original value in the reordered normal play stream and the new value in the slow-forward stream. The placement rule for the start of a frame is then given by:

DTS^{S}−PCRS^{S}=DTS^{N}−PCRS^{N} (20)

which can be rewritten to:

DTS^{S}−DTS^{N}=PCRS^{S}−PCRS^{N} (21)

The offset of a frame in the slow-forward stream with respect to its original position in the normal play stream is given by:

offset=PCRS^{S}−PCRS^{N} (22)

which can be translated to

offset=DTS^{S}−DTS^{N} (23)

The needed DTS values may be calculated for each slow-forward frame and also if necessary for the normal play frames within a GOP that do not have a DTS. Now that the DTS of all the original frames in the normal play stream as well as in the slow-forward stream are available, the offset of these frames can be calculated as the difference between their new and original DTS values. This offset is then used to position the frame and correct the PCR value of PCRS that are present within the data of this frame. The latter is easy; an offset is simply added to the original PCR base. The PCR extension is not changed. This ensures that no drift is introduced between the DTS and the PCR because the correction is in both cases equal to the offset. The relation between the new and original PCR base value is then given by:

PCRbase^{S}=PCRbase^{N}+offset (24)

The positioning of the frame is somewhat more difficult. Positioning is accomplished by a correction of the 4 byte recording time stamp (TST) that is pre-pended to all packets. For this purpose, the offset may be recalculated from a 90 kHz to a 27 MHz basis. A straightforward choice would be to multiply the offset by 300. But here it has to be considered a possible jump in the PCR clock frequency when switching from normal play to slow-forward. Such a jump will never occur if the clock of the time stamp counter was locked to the PCRs during recording, as it should. But if for one reason or another the time stamps are not locked to the PCRs, a jumping PCR clock frequency can still be avoided by using an additional multiplication factor M. This factor is then equal to the ratio of the time stamps and the PCR values of the latest two packets containing a PCR in the recorded normal play stream. Latest means the last two PCR packets before the start of the current frame. This ratio is equal to one in the ideal case of a locked time stamp. Denoting these at least two PCR packets by P₍ₖ₋₁₎ and Pₖ, the offset for the time stamps of all packets of the frame is then given by:

TSToffset=300×offset×M (25)

with

M=(TST^{N}{Pₖ}−TST^{N}{P₍ₖ₋₁₎})/(PCR^{N}{Pₖ}−PCR^{N}{P₍ₖ₋₁₎}) (26)

The PCR values in this formula are in fact the total PCR value based on a 27 MHz clock. This may be calculated from the PCR base and extension in the following way:

PCR=300×PCRbase+PCRext (27)

It is clear that strange results can occur in the calculation of M if there is a wrap in the TST or PCR values between the packets P₍ₖ₋₁₎ and Pₖ. This can be simply avoided. If the value for packet Pₖ is smaller than for the packet P₍ₖ₋₁₎, a value corresponding to the range of TST or PCR has to be added to the value for packet Pₖ prior to this subtraction. This means that the registers for TST and PCR should be one bit wider than normally required. For TST this also means that the additional bit is set to one when this condition occurs and to zero otherwise. The remaining bits are always equal to the original TST bits.

The calculated TST offset is used to correct the time stamps of all packets of this frame. This means that the offset value is added to the recorded time stamps.

In the following, repetition of the B-frames will be explained.

The repetition of the displayed picture resulting from a B-frame is enforced by the repetition of the B-frame data. This results in a series of identical B-frames in the slow-forward stream. The placement of the first frame of this series is similar as in the case of dealing with the positioning of the original normal play frames. The remaining frames are called repeated B-frames. They can be treated in the same way as the first frame, which means that the offset is calculated as the difference between the DTS values in the slow-forward stream and the original recorded stream. The DTS of the recorded frame is identical for the complete series of identical B-frames. In the slow-forward stream, the DTS of a frame is always equal to the DTS of a previous frame increased by Delta. This means that the offset of the repeated B-frames B_{R} can also be calculated with the following formula in which B_{L} denotes the previous B-frame:

offset{B_{R}}=offset{B_{L}}+Delta (28)

The offset is then used in the way described before to correct possibly present PCRs and (after conversion) the time stamps of the packet of the particular B_{R} frame.

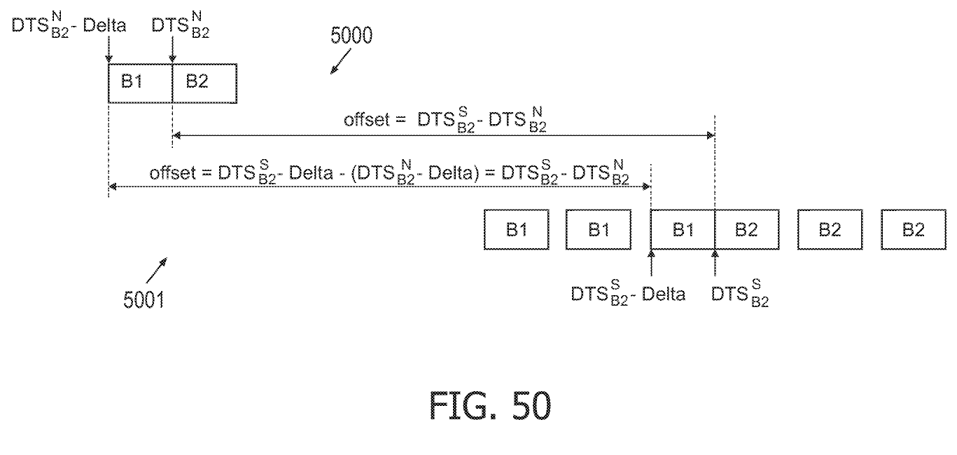

FIG. 50 illustrates an equal offset at the boundaries of a series of identical B-frames. The situation is denoted for normal play (reference numeral 5000) and for slow-forward (reference numeral 5001).

It can be shown that the offset of the first B-frame of a series is equal to the offset of the preceding frame in the slow-forward stream if no empty frames are inserted at this concatenation point. Two situations fulfil this requirement. The first one is when a B-frame is concatenated to a previous anchor frame in the case of pre-insertion of empty frames. The second one is when a B-frame is concatenated to a previous B-frame. FIG. 50 elucidates the effect for the concatenation of the two B-frames. The same is in fact true for the end of the series. Also here the offset of the two frames around the concatenation point is identical if no empty frames are inserted at this point. FIG. 50 also shows this for two concatenated B-frames. The other situation is the concatenation of a B-frame to a subsequent anchor frame in the case that post-insertion of Bf-frames is used.

This means that the two frames around such a concatenation point are connected in the same way as in the normal play stream. For this reason the original packets are always used at such a concatenation point and never the two packets resulting from a split in case the packet contains information from two frames. It is also evident that (as already explained above) no gluing is necessary at such a point. At all other concatenation points the two packets from the split are used if present.

In the following, time compression of B-frames will be illustrated.

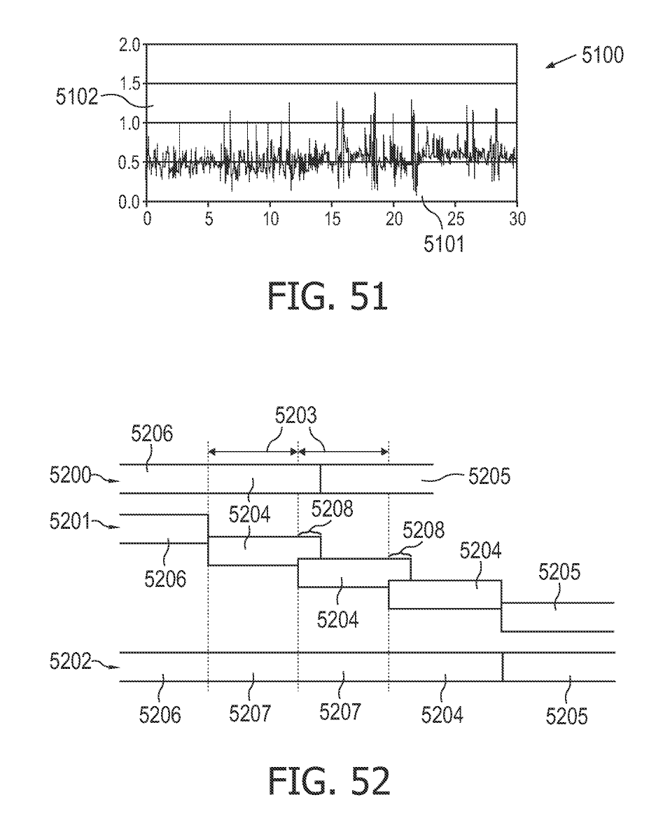

It might be expected that the duration of B-frames will normally be less than one frame time. On average this is true but occasionally the transmission time of B-frames can be larger than one frame time. In a measurement with a duration of roughly 30 seconds, a B-frame of 1.4 frame times was detected. This measurement is depicted in FIG. 51. The average B-frame data length equals 0.6 frames, but regularly the duration of the B-frame data is larger than one frame time.

FIG. 51 shows a diagram 5100 having an abscissa 5101 along which the time in seconds is plotted. Along an ordinate 5102 of the diagram 5100, the length of a frame in number of frame times is plotted.

The positioning of the packets of B-frames by means of a correction of their time stamp with the TSToffset will lead to a correct result as long as the duration of the B-frame is smaller than one frame time. But if a B-frame in the slow-forward stream is larger than one frame time, the end of it will overlap with a subsequent frame because the start of the frames is placed with a distance of one frame time. This is not fully true because the last repeated B-frame would never overlap with the subsequent frame. The situation for a B-frame larger than one frame time is clarified in FIG. 52. FIG. 52 illustrates an overlap of data in case the B-frame is larger than one frame time.

FIG. 52 illustrates a normal play situation 5200, a slow-forward without compression situation 5201 and a slow-forward with compression situation 5202. The frame time is indicated with reference numeral 5203. B-frames have the reference numeral 5204, next frames have the reference numeral 5205, previous frames have the reference numeral 5206 and compressed B-frames are denoted with 5207. Furthermore, overlaps between adjacent frames are denoted with reference numeral 5208.

The type of the previous and next frame has no influence on the effect described. So they can be an anchor frame, a B-frame or even an empty frame.

This means that all the B-frames of a series of identical B-frames except the last have to be compressed in time. This compression can increase the local bit rate even to a level above the maximum bit rate of the total normal play stream. To limit this increase as much as possible, the packets of the B-frame are evenly distributed over the available frame time. The time stamp of the first packet of a B-frame is calculated with the offset rules given earlier. If the packets of the B-frame are denoted by Pⱼ, in which the index j is the packet number within the B-frame, the time stamp of the first packet of a compressed B-frame in the slow-forward stream is given by:

TST^{S}{P₁}=TST^{N}{P₁}+TSToffset (29)

The increment of the time stamp for the subsequent packets of the frame is equal to a value corresponding to one frame time divided by the total number of packets of the frame. Additional packets at the end of the B-frame, like gluing packet and PCR packet, have to be included in this number. Denoting this number of packets by N_{b}, and the distance between the packets of the compressed B-frame by d_{b}, this distance is given by:

d_{b}=300×Delta/N_{b} (30)

The time stamps of the remaining packets of a compressed B-frame and the slow-forward stream are then given by:

TST^{S}{Pⱼ}=TST^{S}{P₍ⱼ₋₁₎}+d_{b} (31)

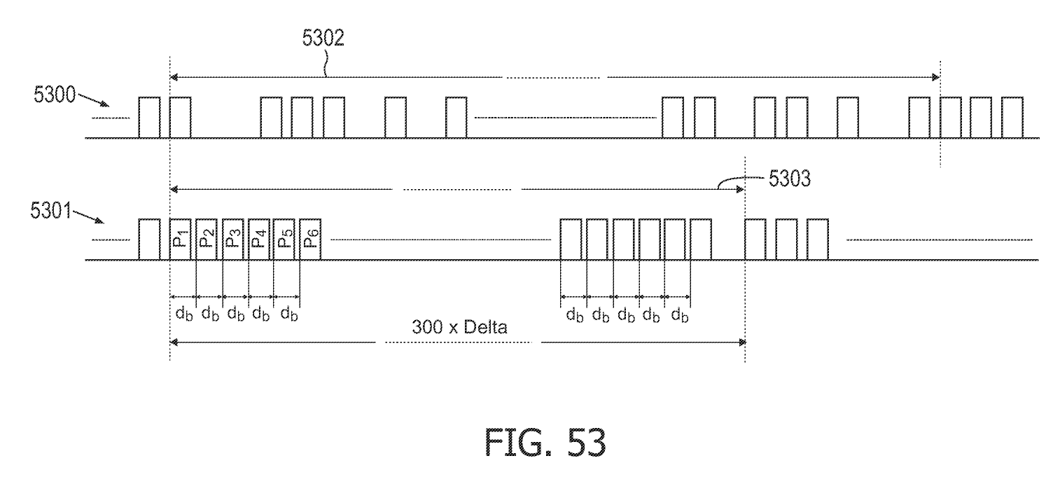

In the non-ideal case, the multiplication factor 300 for the calculation of the distance can lead to a packet distance problem between the last packet of the compressed B-frame and the first packet of the subsequent frame. This could be solved by not taking the factor 300 but instead convert the Delta in the same way as described for the offset. But a pragmatic solution is to take the value of N_{b} one larger than the real number of packets. FIG. 53 shows how a B-frame with irregular packet distance and a duration larger than one frame time is compressed to a B-frame with a duration of one frame time and a constant packet distance. One frame time corresponds to an increment in the time stamp of 300×Delta. The fact that N_{b} is chosen to be one larger than the real number of packets results in some empty space at the end of the compressed B-frame.

Therefore, FIG. 53 illustrates compression of B-frames with evenly distributed packets.

FIG. 53 shows a non-compressed state 5300, a compressed state 5301, shows a B-frame 5302 and a B-frame compressed in one frame time 5303.

It is possible to use the method of equal packet distribution for the B-frames in all cases and not only if compression is needed. But in most cases this means that the B-frame is expanded. The application of the TSToffset to the first packet of a B-frame means that the distance of this packet to the DTS is equal to the normal play stream. The expansion then results in a smaller time distance than original between the end of the B-frame data and the corresponding DTS. But it can be understood that the DTS of a frame can never be earlier than one frame time of the start of the frame data. The reason is as follows: The DTS of a frame and the original stream is by definition always one frame time later than the DTS of the previous frame. The DTS of this previous frame can never be earlier than the end of the data of this frame and therefore never before the start of the data of the current frame. This means that a DTS of an arbitrary frame is at least one frame time later than the start of the data for this frame. This also means that a DTS is always after the end of the frame data, even if this data is evenly distributed in one frame time. So the described equal packet distribution could be applied to all B-frames except the last repeated one. For simplicity, a compressed as well as expanded frame may be named a compressed frame.

Gluing is only necessary between the B-frames of an identical series of B-frames. So a possible additional gluing packet will only be added to the end of a compressed B-frame and never anywhere else. An additional PCR packet is added to the end of the B-frames except to the end of the last repeated B-frame because there is no room at this point. This again means that the additional PCRs are only added at the end of compressed B-frames. So no special placement algorithm is necessary for these packets because they are all included in the compression algorithm.

A consequence from the compression of B-frames is that the correction of the value of a PCR within a frame data is no longer correct for such a B-frame. How this PCR value is corrected in this case and how the value of the PCRs added to the end of a compressed B-frame are calculated will be described in the following. Next, an insertion of the empty frames will be described.

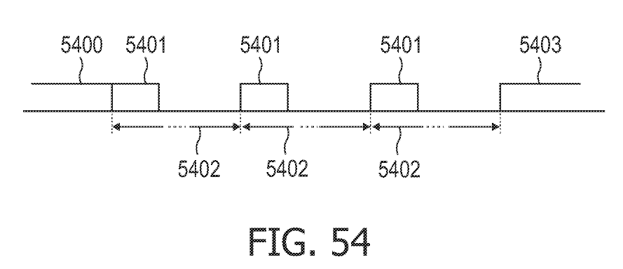

It has to be decided where the inserted empty frames are positioned. Looking at the position of the other frames in the slow-forward stream it is clear that, especially for larger slow-motion factors, a major time gap exists at the point where the empty frames are to be inserted. To avoid problems with an excessive PCR distance, the empty frames should be distributed in this area and each empty frame should contain a PCR. For this reason the distance between successive empty frames is chosen to be one frame time. The first empty frame is directly concatenated to the previous frame. This is shown in FIG. 54.

FIG. 54 shows placement of the empty frames and illustrates the sequence of a previous frame 5400, an empty frame 5401, after a frame time 5402 a further empty frame 5401 is placed, and so on. A next frame is denoted with reference numeral 5403.

The placement algorithm is independent of pre- or post-insertion or the type of empty frame. It should distinguish, however, between the placement of the first packet of the empty frame and the placement of the remaining packets.

In the following, placement of the first packet of an empty frame will be explained.

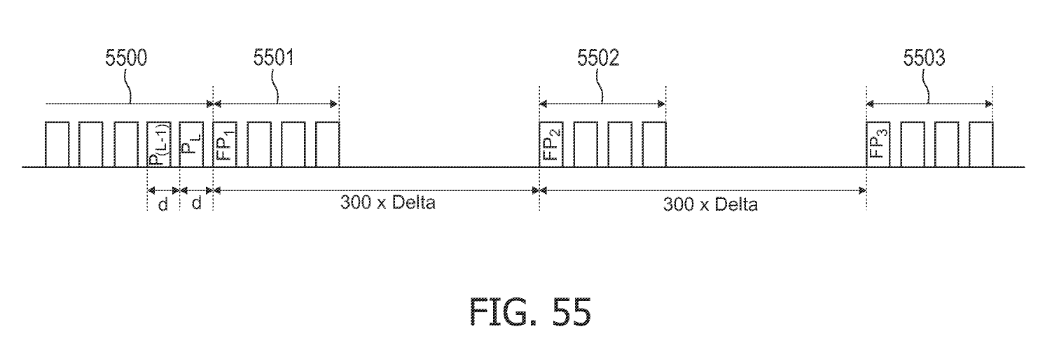

As can be taken from FIG. 55, the positioning of the first packet of the empty frames is described here. A previous frame 5500 is followed by a plurality of empty frames 5501, 5502, 5503, and so on. The first packet of an empty frame is denoted by FPᵢ in which i is the frame number of the empty frame within a sequence of empty frames.

Starting with the placement of FP₁, which is the first packet of the first empty frame, several options exist to derive the time stamp for this packet. One is to add a value d to the slow-forward time stamp of the last packet of the preceding frame. Denoting this last packet again as P_{L}, the time stamp of the first packet of the first empty frame is given by:

TST^{S}{FP₁}=TST^{S}{P_{L}}+d (32)

The value of d can also be chosen in several ways. A possibility is to use the difference between the time stamps of the last two packets of the preceding frame as the value for d. The time stamps can then either be taken from the slow-forward stream or from the original recorded stream, because a compressed frame will never precede the empty frames anyway. Denoting the last two packets of the previous frame by P_{L-1} and P_{L}, the value of d is given by:

d=TST{P_{L}}−TST{P_{(L-1)}} (33)

If the time stamps for the calculation of d are taken from the slow-forward stream, the formula for the calculation of FP₁ can also be written as:

TST^{S}{FP₁}=2×TST^{S}{P_{L}}−TST^{S}{P_{(L-1)}} (34)

The time stamps of the first packets of the subsequent empty frames are acquired by a repeated addition of a value corresponding to one frame time to the time stamp of FP₁. This value can be chosen to be 300×Delta in this case. The time stamps of the first packets of subsequent empty frames are then given by:

TST^{S}{FPᵢ}=TST^{S}{FP₍ᵢ₋₁₎}+300×Delta (35)

In the following, the placement of the remaining packets of an empty frame will be explained.

The packets of an empty frame are denoted by Pⱼ in which j is the packet number within this empty frame. P₁ is the first packet of the empty frame which is denoted above by FP.

The position of the remaining packets is derived from the first packet of an empty frame. For this, it has to be decided on the distance between the packets. This is in fact not critical as long as the distance is not too short because there is ample space available. Two options will be mentioned here.

A first option is to again use the value of d mentioned earlier. This value is then used to increment the time stamps of the packets within the empty frames. These time stamps are then given by:

TST^{S}{Pⱼ}=TST^{S}{P₍ⱼ₋₁₎}+d (36)

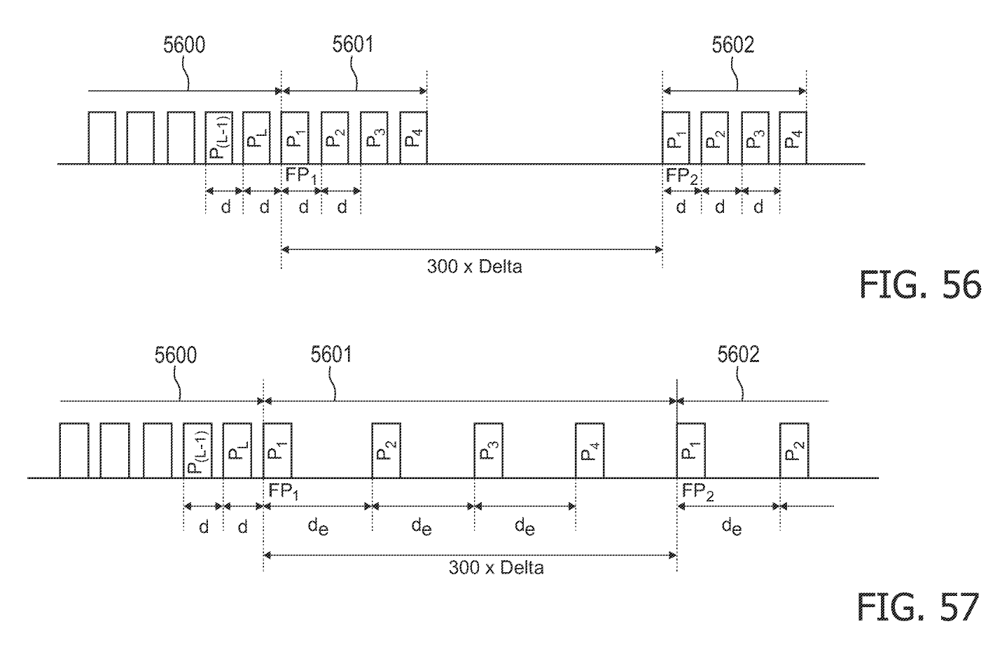

This is depicted in FIG. 56 illustrating a sequence of a previous frame 5600, a first empty frame 5601 and a second empty frame 5602. Therefore, FIG. 56 illustrates the packet distance of the empty frames based on the previous frame.

A second option is to distribute the packets of an empty frame evenly over one frame time. In this case the increment is equal to a value corresponding to one frame time divided by the number of packets of the empty frame. Denoting this number of packets by Nₑ, and a distance between the packets by dₑ, the distance is given by:

dₑ=300×Delta/Nₑ (37)

The time stamps of the packets within the empty frame are then given by:

TST^{S}{Pⱼ}=TST^{S}{P₍ⱼ₋₁₎}+dₑ (38)

This situation is also depicted in FIG. 57 again illustrating a previous frame 5600 followed by a first empty frame 5601 and a second empty frame 5602.

Therefore, FIG. 57 illustrates packets of the empty frame evenly distributed over one frame time.

Next, some aspects related to PCRs are explained.

First, it may be assumed that no additional PCRs are inserted in the slow-forward stream. Because the I-frame is usually much larger than one frame time, it is very probable that it will contain a PCR. For P-frames, the probability is already reduced. B-frames are mostly smaller than one frame time, so a lot of B-frames will not contain a PCR. This means that large gaps within a PCR will occur in the slow-forward stream even though the B-frames are repeated. In general, it is possible to say that the maximum distance between PCRs is increased by the slow-motion factor. This clearly demands for the insertion of additional PCRs in a slow-forward stream.

Apart from original PCRs embedded in the frame data, additional PCRs should be added to an empty frame and at the end of a B-frame. The latter holds with the exception of the end of the last repeated B-frame because there is no room at this point. With these measures it is still possible that the maximum distance exceeds the requirements of the DVB standard, but not to a problematic level. In general, the situation is even more favourable than for fast-forward/fast-reverse.

The correction of PCRs embedded in the frames is described earlier, at least for frames without compressions. Some other method is advantageous to calculate the PCR value of the additional PCRs in the empty frames and at the end of the B-frames as well as for the PCRs within a compressed B-frame. A first option is the following rule: A PCR value is equal to the value of the previous PCR in the slow-forward stream corrected with the difference between the actual slow-forward time stamps of the two packets containing these PCRs. Denoting the packets containing the current and previous PCRs by, respectively, PC and P_{(c-1)}, the current PCR in the slow-forward stream is given by:

PCR^{S}{P_{c}}=PCR^{S}{P_{(c-1)}}+TST^{S}{P_{c}}−TST^{S}{P_{(c-1)}} (39)

Also here PCR stands for the total PCR value calculated from base and extension. This formula is perfect for the ideal case but leads to frequency variations and therefore substantial PCR jitter in the non-ideal case. This is avoided by applying the correction factor M calculated earlier. The current PCR has been given by:

PCR^{S}{P_{c}}=PCR^{S}{P_{(c-1)}}+TST^{S}{P_{c}}−TST^{S}{P_{(c-1)}}/M (40)

The PCR base and extension that have to be inserted in the packet are calculated from the PCR values as follows:

PCRbase=int(PCR/300) (41)

PCRext=PCR−300×PCRbase (42)

Formulas (41), (42) could in fact be used to regulate all PCR values, so including those of the PCRs embedded in non-compressed original frames. However, the calculation with the correction factor may lead to rounding errors that may accumulate, thus resulting in a slow drift of the PCR time base with respect to the DTS. Therefore, in order to reset this drift to zero, the correction of embedded PCRs in non-compressed frames should be performed by an addition of the offset value as described earlier.

A list of abbreviations used in the specification is provided in Table 1.

AFLD Adaptation Field Control

BAT Bouquet Association Table

CA Conditional Access

CAT Conditional Access Table

CC Continuity Counter

CW Control Word

CPI Characteristic Point Information

DIT Discontinuity Information Table

DTS Decoding Time Stamp

DVB Digital Video Broadcast

ECM Entitlement Control Messages

EMM Entitlement Management Messages

GK Group Key

GKM Group Key Message

GOP Group Of Pictures

HDD Hard Disk Drive

KMM Key Management Message

MPEG Motion Pictures Experts Group

NIT Network Information Table

PAT Program Association Table

PCR Program Clock Reference

PES Packetized Elementary Stream

PID Packet Identifier

PLUSI Payload Unit Start Indicator

PMT Program Map Table

PTS Presentation Time Stamp

SIT Selection Information Table

SCB Scrambling Control Bits

STB Set-top-box

SYNC Synchronization Unit

TEI Transport Error Indicator

TPI Transport Priority Unit

TS Transport Stream

UK User Key

Table 1 Abbreviations of terms related to trick-play

It should be noted that the above-mentioned embodiments illustrate rather than limit the invention, and that those skilled in the art will be capable of designing many alternative embodiments without departing from the scope of the invention as defined by the appended claims. Furthermore, any of the embodiments described comprise implicit features, such as, an internal current supply, for example, a battery or an accumulator. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage. The terms “data” and “content” have been used interchangeably through the text, but are to be understood as equivalents.

1. A device (1800) for processing an input data stream comprising a sequence of input frames, wherein the device (1800) comprises
a processing unit (1802) for generating an output data stream as a trick-play stream comprising a sequence of output frames based on the input data stream and based on a predetermined replication rate; and
a timing unit (1803) for assigning timing information to the output frames, said timing information being based on timing information of the sequence of input frames.

2. The device (1800) according to claim 1, wherein the timing unit (1803) is adapted for assigning the timing information to the output frames so that the relative timing information is identical to the relative timing information of the sequence of input frames or so that the relative timing information of the sequence of output frames is corrected with respect to the relative timing information of the sequence of input frames.

3. The device (1800) according to claim 1, wherein the timing unit (1803) is adapted for adjusting Decoding Time Stamps and/or recording timestamps as the timing information.

4. The device (1800) according to claim 1, wherein the timing unit (1803) is adapted for assigning the timing information to the output frames so that a distance between a start of an output frame and a corresponding Decoding Time Stamp is identical to a distance between a start of an input frame and a corresponding further Decoding Time Stamp.

5. The device (1800) according to claim 1, wherein the timing unit (1803) is adapted for inserting a timing packet in the sequence of the output frames at a position between subsequent output frames to be reproduced for the first time.

6. The device (1800) according to claim 5, wherein the timing unit (1803) is adapted for inserting a Program Clock Reference as the timing packet.

7. The device (1800) according to claim 5, wherein the timing unit (1803) is adapted for correcting the timing packet inserted in the sequence of the output frames with respect to a further timing packet of the sequence of the input frames.

8. The device (1800) according to claim 1, wherein the processing unit (1802) is adapted for generating the output frames of the output data stream by stretching the input frames of the input data stream along a time axis in accordance with the predetermined replication rate.

9. The device (1800) according to claim 1, wherein the processing unit (1802) is adapted such that a bi-directional predictive frame is repeated a number of times in accordance with the predetermined replication rate.

10. The device (1800) according to claim 9, wherein the timing unit (1803) is adapted for assigning timing information to repeated bi-directional predictive frames in the same manner as timing information is assigned to bi-directional predictive frames reproduced for the first time.

11. The device (1800) according to claim 1, wherein the timing unit (1803) is adapted such that bi-directional predictive frames having a size exceeding a predetermined threshold value are compressed in time.

12. The device (1800) according to claim 1, wherein the timing unit (1803) is adapted such that bi-directional predictive frames having a size exceeding a predetermined threshold value are compressed in time with exception of a last one of repeated bi-directional predictive frames.

13. The device (1800) according to claim 1, wherein the processing unit (1802) is adapted to insert empty frames to repeat anchor frames in accordance with the predetermined replication rate.

14. The device (1800) according to claim 1, wherein the processing unit (1802) is adapted for generating the trick-play stream according to a trick-play reproduction mode of the group consisting of a slow-forward reproduction mode, a slow-reverse reproduction mode, a stand still reproduction mode, a step reproduction mode, and an instant replay reproduction mode.

15. The device (1800) according to claim 1, wherein the input frames and/or the output frames include at least one frame of the group consisting of an intra-coded frame, a forward predictive frame and a bi-directional predictive frame.

16. The device (1800) according to claim 1, comprising a storing unit (1801) for storing the input data stream and/or the output data stream.

17. The device (1800) according to claim 1, adapted to process an input data stream of video data or audio data.

18. The device (1800) according to claim 1, adapted to process an input data stream of digital data.

19. The device (1800) according to claim 1, comprising a reproduction unit (1806) for reproducing the output data stream.

20. The device (1800) according to claim 1, adapted to process an MPEG2 input data stream or an MPEG4 input data stream.

21. The device (1800) according to claim 1, adapted to process an at least partially encrypted input data stream.

22. The device (1800) according to claim 1, realized as at least one of the group consisting of a digital video recording device;
a network-enabled device;
a conditional access system;
a portable audio player;
a portable video player;
a mobile phone;
a DVD player;
a CD player;
a hard disk based media player;
an Internet radio device;
a computer;
a television;
a public entertainment device; and
an MP3 player.

23. A method of processing an input data stream comprising a sequence of input frames, the method comprising
generating an output data stream as a trick-play stream comprising a sequence of output frames based on the input data stream and based on a predetermined replication rate; and
assigning timing information to the output frames, said timing information being based on timing information of the sequence of input frames.

24. A computer-readable medium, in which a computer program of processing an input data stream comprising a sequence of input frames is stored, which computer program, when being executed by a processor (1805), is adapted to control or carry out the following method:
generating an output data stream as a trick-play stream comprising a sequence of output frames based on the input data stream and based on a predetermined replication rate; and
assigning timing information to the output frames, said timing information being based on timing information of the sequence of input frames.

25. A program element of processing an input data stream comprising a sequence of input frames, which program element, when being executed by a processor (1805), is adapted to control or carry out a method of:
generating an output data stream as a trick-play stream comprising a sequence of output frames based on the input data stream and based on a predetermined replication rate; and
assigning timing information to the output frames, said timing information being based on timing information of the sequence of input frames.
